(19) United States
(12) Patent Application Publication
(10) Pub. No.: US 2026/0355688 A1
(43) Pub. Date: Nov. 12, 2026

(54) REDUCTION OF NOX AND N2O IN THE EXHAUST GAS OF FIRING SYSTEMS OPERATED USING NH3, IN PARTICULAR GAS TURBINES

(71) Applicants: THYSSENKRUPP AG, Essen (DE); THYSSENKRUPP UHDE GMBH, Dortmund (DE)

(72) Inventors: Michael GROVES, Gevelsberg (DE); Meinhard SCHWEFER, Mesched (DE); Rolf SIEFERT, Rheda-Wiedenbrück (DE); Stefan PINNOW, Elsdorf (DE); Jens Christopher JENSEN, Warendorf (DE); Paul KERN, Dortmund (DE); Helmut GEHRKE, Bergkamen (DE)

(21) Appl. No.: 19/142,055

(22) PCT Filed: Dec. 22, 2023
(86) PCT No.: PCT/EP2023/087683

§ 371 Date: Jun. 20, 2025

(30) Foreign Application Priority Data
Dec. 23, 2022 (EP) 22216421.2
Mar. 29, 2023 (EP) 23165192.8

(51) Int. Cl. B01D 53/94

(52) U.S. Cl. CPC B01D 53/9427; B01D 53/9418; B01D 2255/20738; B01D 2255/50; B01D 2255/904; B01D 2257/402; B01D 2257/404

(57) ABSTRACT

The invention relates to the reduction of the content of NOₓ and N₂O in the exhaust gas of a firing system operated using NH₃, in particular a gas turbine operated using NH₃.

Priorities are claimed from European patent application No. 22 216 421.2, filed Dec. 23, 2022; and from European patent application No. 23 165 192.8, filed Mar. 29, 2023.

The invention relates to the reduction of the content of NOₓ and N₂O in the offgas from an NH₃-driven firing system, especially an NH₃-driven gas turbine.

Ammonia is globally one of the most widely produced and distributed chemicals and is best known for its use as a fertilizer in agriculture. In recent years, there has been increasing interest in the possibility of using it as a high-grade energy source and as a carbon-free fuel in internal combustion engines (H. Kobayashi et al., Proceedings of the Combustion Institute 37 (2019) 109-133; D. Erdemir et al., Int J. Energy Res. 2021, 45, 4827-4834; C. Tornatore et al., Frontiers in Mechanical Engineering, 2022, 8, Article 944291). There has also been discussion of use in aircraft (A. Boretti et al., ACS Energy Lett. 2022, 7, 2557-2564).

Ammonia contains no carbon and has a global transport and storage infrastructure. It can be produced directly from renewable power, water and air, and is therefore currently considered to be in-telligent energy source and combustion fuel.

Ammonia has a comparatively low calorific value and a low flame propagation speed, and harbors the risk of flame extinction with the result of incomplete combustion. In addition, the combustion of NH₃ harbors the risk of elevated emissions of nitrogen oxides (in particular NO, NO₂, N₂O), which affects its suitability as a combustion gas. There have been proposals of gaseous ammonia/hydrogen/air mixtures in which a certain hydrogen content is used as combustion accelerator, which would be producible, for example, by catalytic or heat-assisted NH₃ dissociation (Ch. Lhuillier et al., 14th International Conference on Engines & Vehicles, 2019, Capri; S. Mashruk et al., Chemical Engineering Transactions, 89, 2021; S. Mashruk et al., Combustion and Flame 244 (2022) 112299).

WO 2011/136034 relates to an NH₃-burning internal combustion engine which has an offgas treatment catalyst capable of treating NH₃ and NOₓ in the offgas, and a flow gas control unit capable of controlling the ratio of NH₃ to NOₓ in the offgas flowing into the offgas treatment catalyst.

EP 2 378 097 B1 relates to an ammonia-driven machine, wherein an NOₓ catalyst for selective reduction disposed in an offgas duct of the machine is capable of selectively reducing the NOₓ present in an offgas in the presence of ammonia.

EP 3 517 757 A1 relates to a gas turbine which can be fired with NH₃ and/or H₂ and which is equipped with an offgas treatment system.

EP 3 604 929 B1 relates to a combustion apparatus of a gas turbine (A) that has: a combustion chamber; an ammonia supply unit which feeds primary reduction ammonia into the combustion chamber as nitrogen oxide reducing agent and mixes secondary reduction ammonia with combustion offgas discharged from the combustion chamber in order to reduce nitric oxide present in the combustion offgas; and a control unit designed such that it controls at least either the amount of the primary reduction ammonia supplied or the amount of the secondary reduction ammonia mixed with the combustion offgas in accordance with the concentrations of remaining nitric oxide and remaining ammonia present in the combustion offgas after it has been discharged from the combustion chamber.

U.S. Pat. No. 11,702,988 B2 relates to an ammonia decomposition plant comprising a heating medium conduit configured for flow of a heating medium which is heated by the heat generated by a gas turbine, an ammonia supply conduit configured for flow of ammonia, an ammonia decomposition apparatus and an ammonia removal apparatus. The ammonia decomposition apparatus is configured to utilize the heat from the heating medium from the heating medium conduit, thermally decompose ammonia from the ammonia supply conduit, and produce a decomposition gas containing hydrogen, nitrogen and residual ammonia.

US 2018 0355794 A1 relates to a gas turbine system having an ammonia source and a source of an oxygenous gas, a first combustion chamber connected such that it accommodates ammonia, a hydrogen-rich gas stream and oxygenous gas, a turbine connected such that it absorbs an offgas stream from the first combustion chamber, and a second combustion chamber connected such that it accommodates an offgas from the turbine, ammonia and a hydrogen-rich gas stream.

WO 2023 286516 A1 relates to a gas turbine plant comprising: a gas turbine; an ammonia supply device for supplying ammonia to a combustion chamber of the gas turbine; a frame that forms a flow channel that forms an offgas flow duct through which offgas from the gas turbine flows; a water spray device containing a water sprayer capable of spraying water into the offgas flow duct; and a water spray controller for controlling the operation of the water spray device.

C.D. Avila et al., Applications in Energy and Combustion Science 13 (2023) 100104, relates to experimental evaluation of the performance of a commercial microscale gas turbine operated with ammonia-methane mixtures.

L. Balling, Stationäre Gasturbinen [Stationary Gas Turbines], Springer, VDI-Buch (2019) 31-65, relates to gas turbine power plants.

Th. Sattelmayer, Stationäre Gasturbinen, Springer, VDI-Buch (2019) 241-272 relates to principles of combustion in stationary gas turbines.

S. Mashruk et al., Combustion and Flame 244 (2022) 112299, relates to the development of N₂O production in lean combustion in premixed NH₃/H₂/air vortex flames.

E.C. Okafor et al., Combustion and Flame 211 (2020) 406-416 relates to the control of NOₓ and other emissions in microscale gas turbine burners fired with methane-ammonia mixtures.

M. Zhang et al., Int. Journal of Hydrogen Energy 46 (2021) 21013-21025, relates to the regulating effect of methane and hydrogen on emission characteristics.

Operating limits for ammonia-fuel spark ignition engines have been examined. It was found here that NH₃ emissions in the offgas decrease with increasing engine speed, with the highest values being achieved with a rich mixture. NH₃ emissions can reach up to 1% by volume. NOₓ emissions consist mainly of NO, and the effect of the engine speed seems to depend on the equivalence ratio. Although NH₃ does not generate a carbon content in the exhaust, it can emit N₂O, one of the strongest greenhouse gases. Both for NOₓ and N₂O, the highest emission values are observed on the lean side, in that they decrease with increasing equivalence ratio. Finally, even when pure ammonia is combusted under rich conditions, H₂ is produced in the offgas, suggesting local decomposition of the ammonia. The offgas temperatures were likewise monitored and appear to be sufficiently high for the use of catalysts for the selective catalytic reduction (SCR) of NOₓ, in order to reduce both NH₃ and NOₓ emissions at least below 2000 rpm (Ch. Mounaïm-Rousselle et al., Energies 2021, 14, 4141).

CN 114 412 668 A relates to ammonia-fuel engines, in particular an ammonia-hydrogen fusion-type hybrid energy system and an engine.

Y. K. Park, Chemical Engineering Journal, Volume 461, 141958, published Apr. 1, 2023, is a review of the catalytic removal of nitrogen oxides (NO, NO₂, N₂O) from offgas formed when ammonia is used as fuel.

JP 2023 026798A, published Mar. 1, 2023, relates to an offgas processing system of an ammonia engine comprising, as the first catalyst, an oxidation catalyst comprising a catalyst layer containing Pt and zeolite, and, as the second catalyst, a denitration catalyst comprising a catalyst layer containing zeolite that has been ion-exchanged with Cu, Co or Fe ions.

US 2003/0143142 A1 and US 2017/0334722 A1 describe methods of reducing the NOₓ concentration and the N₂O concentration of the tail gas from nitric acid production.

The focal points of research to date have concentrated on the optimization of the combustion of ammonia as such, in particular with regard to energy yield and economic viability, but also with regard to the formation of undesirable nitrogen oxides. However, it can be assumed that it will not be possible to fully suppress the formation of NOₓ (i.e. NO and NO₂) and of N₂O in the combustion process.

Emissions of NOₓ, N₂O and possibly of other constituents that may be present in combustion gases (e.g. CO, HCN or even NH₃) should, however, be avoided or at least reduced as far as possible for protection of health, the environment and the climate. Many industrialized countries have therefore imposed corresponding regulations.

In addition, the combustion of hydrocarbons (CH₄, natural gas, etc.) in the presence of NH₃ gives rise to offgases that can contain hydrogen cyanide (HCN, hydrocyanic acid). Even small amounts of HCN are problematic since it is classified as highly toxic, and correspondingly low limits for emissions of HCN into the environment have to be observed. HCN-contaminated offgases can in principle be purified by various measures. Alkaline scrubbing operations can form and separate off cyanides, but these in turn have to be disposed of as highly toxic compounds. Specific oxidation catalysts based on precious metals can be used to convert HCN to CO₂, H₂O, N₂ and various nitrogen oxides. However, this means not inconsiderable procedural complexity and costs. For instance, the nitrogen oxides formed have to be broken down in a further process step, for example by means of SCR. Also described is passage over specific catalysts, for example based on TiO₂, for hydrolysis of the HCN according to HCN +H₂O→CO+NH₃. In this case too, subsequent further oxidation over corresponding separate oxidation catalysts is then likewise necessary. There is therefore a need for cleaning processes for HCN-contaminated offgases that feature simple and inexpensive modes of operation and low apparatus expenditure. In addition, the processes should convert HCN to nontoxic substances that do not require further treatment.

A further problem is the incomplete combustion of ammonia, which has the effect that the offgases from firing systems operated with ammonia as a fuel can contain considerable amounts of uncombusted ammonia (called NH₃ slip, NH₃ breakthrough). Since the permissible limits for ammonia that can be released to the atmosphere are comparatively strict, it is necessary in such cases to ensure that ammonia is oxidized to nitrogen before the offgas can be released to the atmosphere. For this purpose, what are called ammonia slip catalysts (ASC) have been developed, which are typically based on precious metals from the platinum group (i.e. Ru, Rh, Pd, Os, Ir, Pt). Such catalysts are not only costly but also not very selective (i.e. they can form NOₓ or N₂O from NH₃) and are susceptible to chlorine compounds and other catalyst poisons.

There is therefore a need for measures that are capable of at least partly eliminating
nitrogen oxides (in particular N₂O and NOₓ (i.e. NO and NO₂)),
any excess NH₃, and
any other environmentally harmful components of the offgases (for example CO or HCN), which are present or may be present for combustion-related reasons in the offgas of NH₃-driven firing systems, especially of NH₃-driven internal combustion engines, NH₃-driven gas turbines, or of furnaces for cracking of NH₃ to N₂ and H₂, in order that the offgas can then be discharged into the ambient air in compliance with all environmental regulations.

It is necessary here to take account of the particular circumstances that arise from maximum efficiency of combustion of NH₃ for operation of firing systems, preferably for driving of internal combustion engines, for driving of gas turbines or for driving of furnaces for cracking of NH₃ to N₂ and H₂. Important parameters are not only the different composition of the offgas, but also in particular the pressure and temperature of the offgas. These parameters may differ considerably from those of other offgases for which measures for elimination of NOₓ and N₂O have been developed to date.

For example, in the industrial production of nitric acid NH₃, oxidation is conducted deliberately up to NOₓ in order subsequently to obtain nitric acid therefrom by reacting with water in an absorption tower. Special catalysts made from precious metals are used for the oxidation, and the reaction is frequently effected at elevated pressure. The aim of combustion of NH₃ is to achieve a maximum yield of NOₓ. Typical water contents in the offgas are in the range from about 1% to 3% by volume.

By contrast, in the combustion of NH₃ for operation of firing systems, preferably for operation of internal combustion engines, for operation of gas turbines or for operation of furnaces for cracking of NH₃ to N₂ and H₂, the NH₃ is preferably oxidized only up to the level of N₂, for which no catalysts are typically necessary, and this conversion is usually effected at atmospheric pressure. The aim of the combustion is to achieve a minimum yield of NOₓ and N₂O. Typical water contents in the offgas are well above 3% by volume. For example, the combustion of pure NH₃ in air with a residual oxygen content of 3 mol % affords more than 28 mol % of water. The main aim of the combustion of NH₃ here is the generation of energy. Low levels of nitrogen oxides in the offgas formed in the combustion are advantageous here because in that case only a comparatively small offgas treatment system is required in order to reduce the level of nitrogen oxides in the flue gas and hence comply with the regulatory requirements with regard to permissible emissions, or because only in that case can sufficiently low residual concentrations be achieved at all by known methods of nitrogen oxide reduction, or because only in that case can sufficiently low residual concentrations be achieved at all by known methods of nitrogen oxide reduction.

By contrast with conventional offgas treatment systems as used, for instance, in the case of offgases from plants for production of HNO₃, the inventive combustion of NH₃, preferably in the mixture with H₂, provides special features entailing special measures.

On the one hand are the comparatively low pressures of typically not more than 5 bar, and on the other hand the very high water content is essential. What is meant by “low pressure” is that, in the case of use of conventional catalyst beds based on beds of particulate shaped bodies etc., the pressure drops could possibly be too great. The high water content, because of the hydrothermal load on the catalysts in the offgas treatment system, especially in the case of zeolite material, with simultaneously high temperature can possibly lead to progressive deactivation of the catalysts. The maximum temperature should therefore be limited. Aside from the aging, the chemical reduction of NOₓ is barely impaired by the high water content, while the breakdown of N₂O by decomposition and/or chemical reduction is significantly impaired by the high water content.

A further difference in the offgases to be treated in accordance with the invention by comparison to the production of HNO₃ is the relatively high NOₓ content, which can be several thousand ppmv. The NOₓ content depends on the conditions in the combustion of NH₃, in particular on the NH₃ content, any other combustible gases present (H₂ and/or CH₄ (natural gas)) and the air ratio λ. Because of the high temperatures in the combustion of up to 1000 °C or more, the NOₓ is also present almost exclusively as NO at first, i.e. with a very high proportion of NO and a very low proportion of NO₂. As a result of preferred cooling too, because of the slow formation kinetics of NO₂ at high temperatures, only a small proportion of the NO is converted to NO₂. This means that the degree of oxidation (β) of NOₓ, i.e. the molar proportion of NO₂ in the total NOₓ(β=n(NO₂)/(n(NO)+n(NO₂)), is small when the offgas enters the offgas treatment system, typically <5% by volume. This in turn means that the desired selective catalytic NOₓ reduction can actually proceed very poorly or slowly, in accordance with normal SCR that takes place at a slow rate.

These are fundamental differences from the established offgas cleaning in HNO₃ systems in which the N₂O-and NOₓ-containing tail gas is heated stepwise under a positive pressure of usually 4-10 bar after leaving the absorption tower from a “cold” state (the thermodynamic NOₓ equilibrium is virtually completely to the NO₂ side). For instance, the NOₓ oxidation level of tail gases in HNO₃ production before entry into a corresponding offgas treatment system is typically between 30% and 70% by volume, i.e. close to the ideal stoichiometric ratio for NOₓ reduction in very fast SCR.

The high NOₓ content, combined with a very low NOₓ oxidation level and high water content with simultaneously low operating pressure (close to atmospheric pressure) thus poses particular challenges in the present case to the effectiveness of the offgas treatment system of the invention. In addition, there is the challenge or need to eliminate N₂O which is likewise present in the offgas and is not reducible by conventional SCR methods based on V₂O₅/TiO₂ catalysts.

The objectives and the resultant reaction products in the combustion of NH₃ therefore sometimes differ considerably from one another.

In conventional plants for production of nitric acid, the offgas frequently has, at comparatively high pressure,
a comparatively low content of NOₓ;
a comparatively high proportion of NO₂;
a comparatively high content of N₂O;
a comparatively low content of water; and
a zero proportion of uncombusted NH₃ (NH₃ slip).

In contrast, in combustion plants, preferably for driving combustion engines, for driving gas turbines or for operating furnaces for splitting NH₃ into N₂ and H₂, the offgas often has a comparatively low pressure
a comparatively high content of NOₓ;
a comparatively small proportion of NO₂;
a comparatively low content of N₂O;
a significantly higher content of water;
possibly a not inconsiderable proportion of uncombusted NH₃ (NH₃ slip); and
possibly a non-negligible proportion of HCN, if NH₃ is combusted together with CH₄ (natural gas).

These special circumstances have to be taken into account in the elimination of NOₓ and N₂O from the offgases, which constitutes a particular challenge.

Further challenges in the elimination of NOₓ and N₂O from offgases, by comparison with existing industrial plants, so-called stationary plants, arise from the use of NH₃-operated firing systems, especially NH₃-driven internal combustion engines, in vehicles, ships and possibly also aircraft. The systems are thus not fixedly installed and operated at one site, but are mobile. However, special requirements are placed on mobile systems, for example with regard to weight, size, safety, stability to shocks, etc. In addition, the mode of operation of firing systems, preferably of internal combustion engines, can sometimes change spontaneously, for example when switching from part-load operation to full-load operation, for instance in the case of short-notice acceleration or braking. This too constitutes a particular challenge in the elimination of NOₓ and N₂O from the offgases.

It is an object of the invention to reduce the content of NOₓ (i.e. NO and NO₂), N₂O and, if necessary, NH₃, CO and/or HCN in offgases that are obtained in NH₃-operated firing systems, preferably NH₃-driven internal combustion engines, NH₃-driven gas turbines or furnaces for cracking of NH₃ to N₂ and H₂.

This object is achieved by the subject matter of the claims.

A first aspect of the invention relates to a method of reducing the content of NOₓ and N₂O in the offgas of an NH₃-operated firing system, preferably of an NH₃-driven internal combustion engine, an NH₃-driven gas turbine or a furnace for cracking of NH₃ to N₂ and H₂, wherein the method comprises the following steps:
(a) combusting NH₃ (or NH₃ in mixture with a further combustible gas, in particular H₂, CH₄, etc.) for operation of the firing system, preferably for driving of the internal combustion engine, for driving of the gas turbine or for driving of the furnace for cracking of NH₃ to N₂ and H₂, producing an offgas which comprises N₂, H₂O, NOₓ and N₂O and possibly HCN and which leaves the firing system, preferably the internal combustion engine, gas turbine or furnace;
(b) transferring the offgas from the firing system, preferably the internal combustion engine, gas turbine or furnace, to an offgas treatment system;
(c) reducing the N₂O content in the offgas by
   (c₁) decomposing N₂O over an N₂O decomposition catalyst and/or
   (c₂) chemically reducing N₂O with reducing agent over an N₂O reduction catalyst; and
(d) reducing the NOₓ content in the offgas by chemical reduction of NOₓ with reducing agent over an NOₓ reduction catalyst.

The sequence of steps (c) and (d) is as desired; all options are included in accordance with the invention, from successively in time in any sequence to simultaneously, or mixed forms thereof.

The offgas treatment system of the invention comprises at least
an N₂O reduction catalyst and/or an N₂O decomposition catalyst; and
an NOₓ reduction catalyst;
   which may be the same or different according to the given functionality or multifunctionality and may be present in common or separate reaction zones (catalyst beds).

In preferred embodiments, the offgas treatment apparatus of the invention comprises
an N₂O reduction catalyst;
an N₂O decomposition catalyst; and
an NOₓ reduction catalyst;
   which may be the same or different according to the given functionality or multifunctionality and may be present in common or separate reaction zones (catalyst beds).

In preferred embodiments, the offgas treatment system of the invention additionally comprises at least one further catalyst, or one of the aforementioned N₂O reduction, N₂O decomposition or NOₓ reduction catalyst fulfills at least one further functionality selected from
NH₃ oxidation catalyst;
HCN breakdown catalyst; and
CO oxidation catalyst.

The NH₃ oxidation catalyst is preferably used when the proportion of uncombusted NH₃ in the offgas (NH₃ slip) is greater than the demand for NH₃ as reducing agent for NOₓ and/or N₂O in the offgas treatment system, such that the offgas, after passing through steps (c₁) and/or (c₂) and (d), still contains residual amounts of NH₃ that should not or must not be released to the environment. These residual amounts of NH₃ can then be broken down by oxidation of NH₃ using the downstream NH₃ oxidation catalyst.

The HCN breakdown catalyst is preferably used when the fuel, in addition to NH₃, contains hydrocarbons (CH₄, natural gas, etc.), and the offgas formed in the combustion contains certain amounts of HCN. The resulting HCN can then be broken down (eliminated) with the aid of the HCN breakdown catalyst by hydrolysis of the HCN and oxidation of the hydrolysis products (hydrolyzates) formed in the process, i.e. of NH₃ and CO, with preferably NOₓ and N₂O present in the offgas.

It has been found that, surprisingly, HCN in water-containing offgases which simultaneously contain NOₓ and N₂O, each in a molar amount greater than or equal to the molar amount of HCN, can be broken down to N₂, H₂O and CO₂ by passing the offgas over a zeolitic catalyst laden with transition metals, for example a package of catalyst pellets containing an iron-laden zeolitic material of the BEA structure type, at temperatures of 300 to 600 °C (preferably 350 to 550 °C).

By contrast to known processes, complete elimination of HCN, i.e. a conversion to nontoxic substances, can thus be brought about in a one-stage process, i.e. in one process step without costly precious metal catalysts. In order to eliminate excess levels of NOₓ and N₂O, it is additionally possible to add NH₃ for reduction of NOₓ and N₂O, and optionally CO or hydrocarbons, for example CH₄ or propane, for reduction of N₂O to the HCN-, NOₓ-and N₂O-containing offgas. The amount of reducing agent in this case should be in accordance with the molar starting amounts of N₂O and NOₓ, in each case reduced by the molar amount of HCN present in the offgas. If excess amounts of N₂O are present in the offgas and are to be reduced with NH₃ or CO or hydrocarbon, the NOₓ content should be reduced by means of NH₃ in each case to zero (or close to zero). If CO or hydrocarbons are used as additional reducing agents, any emissions of CO may possibly be eliminated by using an additional CO oxidation catalyst downstream of the zeolite catalyst.

The CO oxidation catalyst is preferably used when (i) hydrocarbons (CH₄, natural gas, etc.) are used as reducing agents for N₂O; and/or (ii) an HCN breakdown catalyst is used to break down HCN, with CO present in the degradation products thereof. Any CO obtained in each case can then be broken down by oxidation to CO₂ with the aid of the downstream CO oxidation catalyst.

If the offgas treatment system of the invention comprises an NH₃ oxidation catalyst, it may be preferable in accordance with the invention to cool the offgas firstly with a heat exchanger within the offgas treatment system to a lower temperature than on entry into the offgas treatment system, such that the NH₃ oxidation catalyst can display its effect in an optimized manner. In preferred embodiments, the offgas treatment system of the invention therefore additionally comprises one or more heat exchangers.

For the purposes of the description “and/or” means either “or” or “and”, such that, for example, “A and/or B” has the following three meanings: (i) only A but not B, (ii) only B but not A, and (iii) both A and B.

For the purposes of the description, “NOₓ” includes nitrogen monoxide (NO) and nitrogen dioxide (NO₂), but not nitrous oxide (N₂O).

Catalysts accelerate certain chemical reactions by lowering their activation energies.

Unless explicitly stated otherwise, all figures in ppm are based on volume, i.e. ppmv. Unless explicitly stated otherwise, all percentages are based on volume with regard to gas composition, i.e. % by volume. Unless explicitly stated otherwise, all other percentages are based on weight, i.e. % by weight.

Steps (a) and (b) of the method of the invention are performed successively in alphabetical sequence, followed by steps (c) and (d) in fundamentally any sequence. Step (c) can accordingly be performed before step (d) or after step (d) or simultaneously with step (d). Also possible are mixed forms of partial simultaneousness. This may be relevant particularly when one and the same catalyst material is capable of catalyzing multiple reactions. Such embodiments are particularly preferred in accordance with the invention. According to the invention, these reactions then possibly take place simultaneously, although the kinetics of the respective reactions may vary, such that a first reaction may have ended earlier or may have reached a higher conversion than a second reaction proceeding in parallel.

Steps (c₁) and (c₂) are considered separately for the purposes of the description, but both serve the common purpose of reducing the N₂O content in the offgas.

Steps (c₁), (c₂) and (d) can likewise be performed in any sequence, although mixed forms of partial simultaneousness are also possible in this regard.

In preferred embodiments, the method of the invention comprises steps (a), (b), (c₁) and (d); steps (a), (b), (c₂) and (d); or steps (a), (b), (c₁), (c₂) and (d).

In preferred embodiments, the offgas undergoes the steps of the method of the invention in one of the following sequences:
(i) (a)→(b)→(c₁)→(d);
(ii) (a)→(b)→(d)→(c₂);
(iii) (a)→(b)→(d)→(c₂)→(c₁);
(iv) (a)→(b)→(d)→(c₁+c₂); or
(v) (a)→(b)→(d)→(c₁).

What is meant by (c₁+c₂) is that both step (c) and step (c₂) are performed, although the performance of these two steps (c₁) and (c₂) is at least partly simultaneous, i.e. both steps proceed in parallel.

Between these steps, there may be further steps that are not specified explicitly.

In step (a) of the method of the invention, the combustion of NH₃ is effected for operation of a firing system.

“Firing systems” in the context of the invention generate heat through combustion processes. Firing of fuels generates heat. It is optionally additionally also possible here to generate power and/or drive machines. The term covers a wide range of different systems: from domestic heating, motors for driving vehicles, through industrial firing systems for steam and process heat generation, to large-scale power plant firing systems. “Firing systems” in the context of the invention are any systems in which NH₃ is oxidized with O₂ (preferably from the air) with the aim of producing N₂ and H₂O in particular as the main products. Systems in which NH₃ is oxidized with O₂ with the aim of producing nitrogen compounds with higher oxidation numbers (e.g. NOₓ) as the main products, as is the case, for example, in the production of nitric acid, are not firing systems in the context of the invention.

The combusting of NH₃ means the oxidation of NH₃ with O₂, where this reaction, in accordance with the invention, does not have to be complete, such that the offgas may contain residual uncombusted (unoxidized, unconverted) NH₃ (NH₃ slip, NH₃ breakthrough). The same applies if NH₃ is combusted not in pure form but together with other combustible gases, in particular H₂ and/or CH₄ (natural gas). The O₂ used for combustion can be used in the form of combustion air, where the combustion air may optionally be enriched with O₂.

According to the invention, NH₃ is preferably combusted in the mixture with H₂ or fossil fuels, e.g. CH₄.

In preferred embodiments, in step (a) of the method of the invention, the combustion of NH₃ is effected for driving of an internal combustion engine.

“Internal combustion engines” (heat engines) within the context of the invention are in particular combustion engines, preferably piston heat engines with internal combustion, such as reciprocating piston engines or rotary piston engines.

In preferred embodiments, in step (a) of the method of the invention, the combustion of NH₃ is effected for driving of a gas turbine.

“Gas turbines” in the context of the invention are in particular internal combustion engines in which an offgas flow is generated and can be used, for example, to generate (mechanical) rotational energy by means of an offgas expansion turbine.

It has been found that, surprisingly, the method of the invention is particularly suitable for gas turbines and has several advantages compared to conventional methods. For instance, the method of the invention features a lower air volume requirement and simplified gas turbine operation. In addition, high degradation rates for N₂O and NOₓ are assured, and this in addition with only low consumption of reducing agents (especially NH₃). Emissions of N₂O and NOₓ can be reduced within the offgas treatment system, especially when the offgas treatment plant is equipped with two series-connected catalyst beds. The advantages of “end-of-pipe technology” are manifested. The catalysts used are nontoxic and have a long service life. The pressure drop is only low, and the catalysts and the method can be used over a wide temperature range.

In this context, it is relevant that the most modern gas turbines have turbine inlet temperatures of more than 1500 °C and hence offgas temperatures of more than 600 °C. Conventional SCR catalysts based on vanadium oxide cannot be used at temperatures above 400 °C owing to irreversible damage. By contrast, the zeolite catalysts preferred in accordance with the invention can be used within a wide temperature range from about 350 up to 600 °C and hence also at higher temperatures. It may therefore be possible in accordance with the invention to dispense with complex cooling of the offgas.

In preferred embodiments, in step (a) of the method of the invention, NH₃ is combusted in order to operate a furnace for cracking of NH₃ to N₂ and H₂.

In step (b) of the method of the invention, the offgas is transferred to an offgas treatment system, i.e. from the internal combustion engine or gas turbine to an offgas treatment system. Steps (c) and (d) of the method of the invention are effected in the offgas treatment system of the invention. For this purpose, the offgas treatment system is equipped with the N₂O decomposition catalyst for step (c₁) and/or with the N₂O reduction catalyst for step (c₂), and with the NOₓ reduction catalyst for step (d).

If the offgas treatment system of the invention additionally comprises at least one further catalyst, or one of the aforementioned N₂O reduction, N₂O decomposition or NOₓ reduction catalysts fulfills at least one further functionality, at least one of the following steps (e₁) to (e₄) is preferably additionally effected in the offgas treatment system of the invention:
(e₁) cooling the offgas in at least one heat exchanger which is preferably disposed within the offgas treatment system; preferably upstream of the NH₃ oxidation catalyst in flow direction of the offgas;
(e₂) reducing the NH₃ content in the offgas by oxidation with an oxidizing agent over an NH₃ oxidation catalyst; where the oxidizing agent preferably comprises O₂;
(e₃) reducing the HCN content in the offgas by hydrolysis and oxidation of the hydrolyzates with an oxidizing agent over an HCN breakdown catalyst; where the oxidizing agent preferably comprises NOₓ and/or N₂O; and
(e₄) reducing the CO content in the offgas by chemical oxidation with an oxidizing agent over a CO oxidation catalyst; where the oxidizing agent preferably comprises O₂.

In step (c) of the method of the invention, the N₂O content in the offgas is reduced. This can be effected by (c₁) decomposition of N₂O over an N₂O decomposition catalyst and/or (c₂) chemical reduction of N₂O with reducing agent over an N₂O reduction catalyst.

The decomposition of N₂O forms N₂ and O₂ according to the following empirical reaction:

2N₂O→2N₂+O₂.

Decomposition of N₂O therefore means breakdown to N₂ and O₂. An “N₂O decomposition catalyst” in the context of the invention catalyzes the decomposition of N₂O. The achievable breakdown of N₂O by catalytic decomposition depends not only on the type, i.e. the chemical nature and physical configuration, of the N₂O decomposition catalyst and the pressure and temperature conditions that exist, but also in particular on the chosen space velocity, i.e. the ratio of offgas volume flow rate to catalyst volume. However, the catalytic activity of an N₂O decomposition catalyst need not be restricted exclusively to this reaction. For instance, it is quite possible and indeed preferred in accordance with the invention that the N₂O decomposition catalyst can additionally also catalyze further reactions, for example the chemical reduction of N₂O and/or the chemical reduction of NOₓ. Whether such further reactions do indeed take place depends on the conditions of the individual case, in particular the type of catalyst, and the kinetics of any processes that take place in parallel, for example on the presence or amount of the reducing agent and the presence or amount of other coreactants.

The chemical reduction of N₂O with reducing agent forms different reaction products depending on the reducing agent.

In the case of the NH₃ reducing agent that is preferred in accordance with the invention, the chemical reduction of N₂O forms N₂ and H₂O in particular, for example as follows:

3 N₂O+2 NH₃→4N₂+3 H₂O or

4 N₂O+4 NH₃+O₂→6 N₂+6 H₂O

or else in joint reduction with NO as follows:

2 NO+N₂O+2 NH₃→3 N₂+3 H₂O.

In the case of hydrocarbons, which are likewise preferred in accordance with the invention as reducing agent, the chemical reduction of N₂O forms CO and H₂O in particular, for example as follows:

(2n+1) N₂O+CₙH₂ₙ₊₂→(2n+1) N₂+n CO+(n+1) H₂O

or else CO₂ and H₂O as follows:

4 N₂O+CₙH₂ₙ₊₂→4n N₂+n CO₂+2n H₂ O.

CO is likewise preferred in accordance with the invention as reducing agent. It can react further with N₂O to give CO₂, for example according to:

N₂O+CO→N₂+CO₂.

An “NOₓ reduction catalyst” in the context of the invention catalyzes the chemical reduction of NOₓ with reducing agent. However, the catalytic activity of an NOₓ reduction catalyst need not be restricted exclusively to this reaction. For instance, it is quite possible and indeed preferred in accordance with the invention that the NOₓ reduction catalyst can additionally also catalyze further reactions, for example the decomposition of N₂O, the chemical reduction of N₂O and/or the establishment of the NOₓ equilibrium or else the selective oxidation of excess NH₃ with free O₂. Whether such further reactions do indeed take place depends on the conditions of the individual case and the kinetics of any processes that take place in parallel, for example on the presence or amount of the reducing agent and the presence or amount of other coreactants.

In step (d) of the method of the invention, the NOₓ content in the offgas is reduced by chemical reduction of NOₓ with reducing agent over an NOₓ reduction catalyst.

Preference is given here to those NOₓ reduction catalysts which as far as possible enable the selective catalytic reduction (SCR) of the nitrogen oxides present in the offgas, in particular of NOₓ, meaning that the NOₓ reduction catalysts primarily catalyze the oxidation of NH₃ with NOₓ and do not catalyze, or only secondarily catalyze, the oxidation of NH₃ with any free oxygen (O₂) present in the offgas.

The chemical reduction of NOₓ with reducing agent forms different reaction products depending on the reducing agent. In the case of the NH₃ reducing agent that is preferred in accordance with the invention, the chemical reduction of NOₓ forms N₂ and H₂O in particular, depending on the type of NOₓ reduction catalyst and the ratio of NO to NO₂, for example as follows:

4 NH₃+2 NO+2 NO₂→4 N₂+6 H₂O (fast SCR)

4 NH₃+4 NO+O₂→4 N₂+6 H₂O (normal SCR)

8 NH₃+6 NO₂→7 N₂+12 H₂O (NO₂ SCR).

Common selective catalytic reduction is referred to as fast SCR and is generally much faster than normal SCR or NO₂ SCR.

An “NOₓ reduction catalyst” in the context of the invention catalyzes the chemical reduction of NOₓ with reducing agent. However, the catalytic activity of an NOₓ reduction catalyst need not be restricted exclusively to this reaction. For instance, it is quite possible and indeed preferred in accordance with the invention that the NOₓ reduction catalyst can additionally catalyze further reactions, for example the decomposition of N₂O and/or the chemical reduction of N₂O and/or the establishment of the NOₓ equilibrium or the selective oxidation of excess NH₃ with free O₂. Whether such further reactions do indeed take place depends on the conditions of the individual case and the kinetics of any processes that take place in parallel, for example on the presence or amount of the reducing agent and the presence or amount of other coreactants.

### Catalysts

N₂O decomposition catalysts are known per se, and it is possible to use a wide variety of substance classes. Preference is given to N₂O decomposition catalysts which have a high catalytic activity, for example, in the temperature range from 350 to 600 °C for decomposition of N₂O to N₂ and O₂.

Examples of N₂O decomposition catalysts that are preferred in accordance with the invention are metal-laden zeolite catalysts, for example copper-or cobalt-or in particular iron-laden zeolite catalysts, precious metal catalysts or else transition metal oxide catalysts, for example cobalt oxide-containing catalysts. Examples of suitable catalysts are described inter alia by Kapteijn et al. in Appl. Cat. B: Environmental 9 (1996), 25-64, in US-A-5, 171, 553, in Actes du 2ieme Congres International sur la Catalyse, Technip, Paris 1961, 1937-1953, and in WO-A-01/58,570. When iron-laden zeolite catalysts are used in the first catalyst bed, the NOₓ still present in the gas, as expected, accelerates the desired N₂O decomposition by an activating effect (cocatalytic effect), as described for different N₂O/NOₓ ratios by Kögel et al. in Catal. Comm. 2 (2001) 273-276.

Further examples of N₂O decomposition catalysts that are preferred in accordance with the invention are catalysts having activity for N₂O decomposition which is distinctly limited by the presence of NOₓ. Such N₂O decomposition catalysts are also referred to as “NOₓ-sensitive N₂O decomposition catalysts” for the purposes of the description. These catalysts contain one or more catalytically active compounds of elements selected from groups 5 to 11 of the Periodic Table of Elements (PTE). Especially preferred are compounds of the elements of group 9 to 11 of the PTE. Among these, preference is given in turn to the compounds of the elements Co, Pt, Pd, Ir, Rh, Ni and/or Cu, preferably Co, Rh, Ni and/or Cu, and here in particular Co or Rh. Preference is given to an N₂O decomposition catalyst based on precious metals, which are preferably supported on refractory oxides, or based on mixtures of transition metal oxides, in particular mixed oxides or simple transition metal oxides, in each case either in supported form or preferably as unsupported catalysts.

The catalytically active compounds themselves may be metallic and/or oxidic compounds, the latter either in the form of singular oxides or in the form of binary, ternary or polynary mixed oxides of different structure types, for example perovskites or spinels. These are described, for example, in Catalysis Letters 35 (1995) 372-382, Applied Catalysis 73 (1991) 165-171, Catal. Rev.-Sci. Eng. ; 34(4), 409-425 (1992) or Actes du 2ieme Congres International sur la Catalyse 97 (1961) 1937-1953. Mixtures of different catalytically active compounds may also be used. Examples of particularly preferred catalytically active compounds are metallic rhodium, rhodium oxides, such as RhO₂, or Rh₂O₃, CoO, Co₂O₃, Co-containing spinels, such as Co₃O₄, CuₓCo₃₋ₓO₄, or Co-containing perovskites such as LaCoO₃ or Co-containing perovskites substituted at A and B sites.

The catalytically active compounds may be present in the catalysts in pure form or may be applied to or mixed with suitable support materials. In the former case, they are what are called unsupported catalysts which, in addition to active compounds, may contain additives known to the skilled person, such as binders or other production-related additives such as plasticizers, pore formers, fiber reinforcements or compression aids.

The methods of producing such catalysts are known to the skilled person. In the case of “supported catalysts”, the catalytically active compounds have been applied to the support material. As a result, the catalytically active compound undergoes dispersion and stabilization against both mechanical and thermal stress. The methods of producing such catalysts are likewise known to the skilled person. The support materials are preferably refractory oxides, such as SiO₂, TiO₂, ZrO₂ or Al₂O₃, or mixtures of two or more of these, or materials which themselves have a certain catalytic activity for N₂O decomposition, such as MgO, zeolites, hydrotalcites or mixtures of two or more of these. Preference is given to using catalysts which contain essentially no zeolites, if any, preferably less than 15% by weight of zeolites, in particular less than 5% by weight of zeolites.

Preferred support materials for Rh-containing compounds are ZrO₂, TiO₂, Al₂O₃, hydrotalcites or zeolites, for example of the MFI structure type. These are described, for example, in Chemical Engineering and Technology 24 (2001) 281-285 or in Catalysis Today 35 (1997) 113-120. Particularly preferred supports for Rh-containing compounds are ZrO₂, TiO₂ and hydrotalcites. The Rh content of these catalysts is preferably 0.1% to 10% by weight, preferably 0.5% to 5% by weight. In addition to Rh, Rh-containing catalysts more preferably also contain CeO₂. The proportion of CeO₂ is preferably 5% to 50% by weight, in particular 10% to 30% by weight.

Preferred supports for Co-containing compounds are zeolites, or the preferred supports contain magnesium oxide. In the case of zeolites, particular preference is given to Si-rich structure types such as MFI, BEA, FER, MEL or MOR. The production of such Co-doped zeolites is known to the skilled person. Magnesium oxide supports may be pure MgO or MgO-containing compounds, for example hydrotalcites. Such catalysts are described, for example, in Appl. Catal. B: Environmental 7 (1996) 397-406 or Appl. Catal. B: Environmental 13 (1997) 69-79.

Particular preference is given to catalysts consisting essentially of at least one oxidic magnesium compound and at least one oxidic cobalt compound, where the content of oxidic cobalt compounds is in the range from 0.1% to 50% by weight and the content of oxidic magnesium compounds is in the range from 50% to 99.9% by weight, based in each case on the total mass of the catalyst, and at least 30% by weight of the Co atoms present in the catalyst are in the chemically trivalent state. Such catalysts and the preparation thereof are described in EP 1 257 347 B1. Also particularly preferred in the case of use of oxidic Co compounds as active component are catalysts having a support consisting of at least 50% by weight of MgO or of a mixed oxide consisting of at least 50% by weight of MgO, and where a cerium oxide functional layer has been applied to the support. Such catalysts and the preparation thereof are described in DE 10 2007 038 711 A1 .

The N₂O decomposition catalyst may take the form of shaped bodies of any size and geometry, preferably geometries having a high ratio of surface area to volume, with generation of a minimum pressure drop as they are traversed. All geometries known in catalysis are typical, for example cylinders, hollow cylinders, multi-hole cylinders, rings, crushed granulate, trilobes or honeycomb structures.

N₂O reduction catalysts and NOₓ reduction catalysts are likewise known per se, and a wide variety of substance classes can likewise be used. Examples of these are metal-laden zeolite catalysts, such as copper-or cobalt-laden zeolite catalysts, or in particular iron-laden zeolite catalysts, or precious metal catalysts or catalysts that are used in the known SCR (selective catalytic reduction) processes.

Preferably, the N₂O decomposition catalyst and/or the N₂O reduction catalyst and/or the NOₓ reduction catalyst independently comprise a zeolitic material; preferably a zeolite laden with transition metal (including lanthanide), in particular with iron, cobalt or copper; more preferably an iron-laden zeolite; even more preferably independently an iron-laden zeolite of the MFI, BEA, FER, MOR, FAU and/or MEL structure type.

Preferably, both the N₂O decomposition catalyst and/or the N₂O reduction catalyst and the NOₓ reduction catalyst independently comprise a zeolitic material; preferably a zeolite laden with transition metal (including lanthanide), in particular with iron, cobalt or copper; more preferably an iron-laden zeolite; even more preferably independently an iron-laden zeolite of the MFI, BEA, FER, MOR, FAU and/or MEL structure type.

These may be different catalysts or the same catalysts. Iron-laden zeolite catalysts that are used with particular preference in accordance with the invention essentially contain preferably >50% by weight, in particular >70% by weight, of one or more iron-laden zeolites. For example, in addition to a Fe-ZSM-5 zeolite, a further iron-containing zeolite such as an iron-containing zeolite of the FER type, may be present in the catalyst used in accordance with the invention.

In addition, the catalyst used in accordance with the invention may contain further additives known to the skilled person, for example binders.

The iron content of the zeolites used with preference may be up to 25% based on the mass of zeolite, but preferably 0.1% to 10%.

The method of the invention also includes the use of zeolites in which the lattice aluminum has been partly isomorphically substituted by one or more elements, for example replaced by one or more elements selected from B, Be, Ga, Fe, Cr, V, As, Sb, and Bi. Likewise included is the use of zeolites in which the lattice silicon is isomorphically substituted by one or more elements, for example by one or more elements selected from Ge, Ti, Zr and Hf. Exact details of the formation or structure of the zeolites preferably used in accordance with the invention is given in the Atlas of Zeolite Structure Types, Elsevier, 4th revised edition 1996, which is hereby explicitly incorporated by reference.

Very particular preference is given in the method of the invention to the use of zeolite catalysts that have been treated with water vapor (“steamed” catalysts). Such a treatment dealuminates the lattice of the zeolite; this treatment is known per se to the skilled person. These hydrothermally treated zeolite catalysts are notable for particularly high activity in the method of the invention. Preference is given to using hydrothermally treated zeolite catalysts that have been laden with iron and in which the ratio of extra-lattice aluminum to lattice aluminum is at least 1:2, preferably 1:2 to 20:1.

The N₂O decomposition catalyst and/or the N₂O reduction catalyst and the NOₓ reduction catalyst preferably each independently comprise transition metal-laden zeolites, preferably respectively iron-laden zeolites (Fe zeolites), even more preferably respectively iron-laden zeolites of the same structure type, most preferably with the same outer shape (e.g. honeycomb or pellet).

In preferred embodiments, the N₂O decomposition catalyst and the N₂O reduction catalyst are made from the same material.

In preferred embodiments, the N₂O decomposition catalyst and the NOₓ reduction catalyst are made from the same material.

In preferred embodiments, the N₂O reduction catalyst and the NOₓ reduction catalyst are made from the same material.

In preferred embodiments, the N₂O decomposition catalyst, the N₂O reduction catalyst and the NOₓ reduction catalyst are made from the same material.

### Preferred Catalysts for the Breakdown of N₂O and NOₓ

The N₂O decomposition catalysts, N₂O reduction catalysts, and NOₓ reduction catalysts of the invention preferably independently contain zeolitic materials (for the purpose of the description also “zeolites”) laden with at least one transition metal (atomic numbers 21-30, 39-48, 57-80, 89-112) and/or at least one lanthanoid (also called “lanthanide”; atomic numbers 57-71). For the purposes of the description, transition metals and lanthanoids are collectively referred to as “transition metals” for the sake of simplicity. The transition metals are preferably iron (“Fe zeolites”), copper (“Cu zeolites”) and cobalt (“Co zeolites”). Iron-laden zeolitic materials (i.e. Fe zeolites) are particularly preferred and may be laden with or contain not only iron but also other transition metals, for example manganese, vanadium, chromium, nickel or mixtures.

The zeolitic materials of the invention preferably have high hydrothermal stability. Particular preference is given to SiO₂-rich zeolites, called “high-silica zeolites”, which have a molar ratio of [SiO₂] to [AlO₂⁻] units, and hence a molar Si/Al ratio of at least 8, preferably at least 9, more preferably at least 10, even more preferably at least 11, most preferably at least 12, and in particular at least 13.

Zeolitic materials that are preferred in accordance with the invention essentially have a zeolite structure of the BEA, MFI, MOR, MEL or FER structure type, more preferably of the MFI and BEA structure type, even more preferably of the BEA structure type. In the case of the MFI structure type, the ZSM-5 structure type in particular is preferred. Further details of the naming of the structure types of zeolitic materials and their structure can be found in the Atlas of Zeolite Structure Types, Elsevier, 4th revised edition 1996.

N₂O decomposition, N₂O reduction or NOₓ reduction catalysts that are particularly preferred in accordance with the invention independently contain at least 50% by weight of Fe zeolite in relation to the total weight of the zeolitic material, preferably at least 70% by weight of Fe zeolite, where a single structure type or else several structure types may be present. In preferred embodiments, in addition to Fe-BEA zeolite, another Fe zeolite of a different structure type is present, preferably Fe-MOR zeolite.

The loading (doping) of the zeolitic materials with the transition metals/lanthanoids can be effected by relevant methods of loading or doping zeolites with transition metals/lanthanoids that are known to the skilled person. The loading preferably proceeds from the commercially available H form or preferably NH₄ form of the zeolitic materials by ion exchange with appropriate salts of the transition metals, in an aqueous phase or by solid-state reaction. The laden zeolitic materials thus obtained are then calcined, preferably under air in a furnace at temperatures in the range from 400 to 650 °C. After calcination, the laden zeolitic materials are vigorously washed in distilled water, and the laden zeolitic materials are filtered off and then dried. Suitable binders, for example aluminosilicates, boehmite or silica sol, and optionally auxiliaries for plasticization or for production of slips, are preferably added to and mixed with the laden zeolitic materials thus obtained. In preferred embodiments, the mixtures thus obtained are extruded to catalyst bodies (unsupported catalysts) and finally calcined. In other preferred embodiments, the mixtures thus obtained are applied to catalyst supports (supported catalysts) and finally calcined. These methods are also well known to the skilled person and established in many technical applications.

The N₂O decomposition, N₂O reduction, NOₓ reduction, NH₃ oxidation, HCN breakdown and CO oxidation catalysts of the invention may independently take the form of shaped bodies of any size and geometry, preferably in geometries that have a large surface-to-volume ratio and generate a minimum pressure drop as the stream flows through them. Typical geometries are all of those known in catalysis, for example cylinders, hollow cylinders, multihole cylinders, rings, trilobes or star-shaped extrudates. Particular preference is given to monolithic catalyst elements permeated by parallel channels, for example monolithic honeycombs, known as “catalyst honeycombs”, which are known, for example, from the cleaning or denoxing of power plant offgases or automotive exhaust gases.

### Catalyst Honeycombs, Honeycomb Bodies and Honeycomb Body Modules

The offgas treatment system of the invention or the catalyst beds encompassed therein preferably comprise catalyst honeycombs, preferably a plurality of catalyst honeycombs, arranged parallel to one another with honeycomb channels in the offgas duct that are aligned longitudinally to the flow direction of the offgas. The geometry of the cross-sectional area of the catalyst honeycombs (perpendicular to the flow direction of the offgas) can in in principle be chosen freely. The catalyst honeycombs preferably have a rectangular or, in particular, square cross-sectional area, but other cross-sectional areas are also possible, in particular hexagonal, triangular, trapezoidal, etc. Suitable geometries are known to those skilled in the art. Accordingly, the term “honeycomb”, according to the invention, is not limited to a rectangular or square cross-sectional area.

If the offgas treatment system of the invention comprises a first reaction zone (first catalyst bed) and a second reaction zone (second catalyst bed) downstream in flow direction of the offgas, which is preferred in accordance with the invention, the first and second reaction zones (the first and second catalyst beds) preferably have several catalyst honeycombs that are arranged parallel to one another with honeycomb channels in the offgas duct that are aligned longitudinally to the flow direction of the offgas.

In preferred embodiments, several catalyst honeycombs, i.e. several monolithic honeycomb bodies, are combined to form a honeycomb body module, preferably by means of a metal frame which is open in flow direction of the offgas. Preferably, two, four or six honeycomb bodies, preferably monolithic honeycomb bodies, in each case are combined to form a honeycomb body module. This modular construction allows good utilization of the available cross-sectional area of the offgas duct and simple exchange of defective or deactivated honeycomb bodies.

The honeycomb bodies preferably have a rectangular cross section. The rectangular cross section preferably has a first edge length (perpendicular to the flow direction of the offgas) in the range of 5 to 20 cm, more preferably 10 to 15 cm, and a second edge length (also perpendicular to the flow direction of the offgas) in the range of 5 to 20 cm, preferably 10 to 15 cm. The height of a honeycomb body (flow direction of the offgas) is preferably in the range from 5 to 25 cm, preferably in the range from 7.5 to 15 cm.

What is called the cell density, i.e. density of the channels of a single catalyst honeycomb, is preferably 150 to 500 cpsi, preferably 180 to 450 cpsi (cells per square inch). 100 cpsi, i.e. 100 cells or honeycomb channels per square inch, corresponds to about 15.5 catalyst channels per cm².

Preferably, the individual honeycomb body modules are stacked on top of one another and alongside one another in flow direction and fixed by appropriate mount devices in such a way as to achieve maximum exploitation of the inflow area, i.e. cross-sectional area of the offgas duct. Bypass flows between each honeycomb body module or in the outer edge area between the outer margin of the honeycomb body module and the inner wall of the offgas duct should be avoided. For this purpose, suitable sealing materials are preferably applied between the individual honeycomb body modules and between the outer honeycomb body modules and the inner wall and, in the case of greater wall separations, cover plates are used, which are mounted on the inner wall of the offgas duct in flow direction in front and/or behind the packing of the honeycomb body modules. The cover plates are preferably covered with seals at the contact points with the honeycomb body modules. The honeycomb body modules are preferably arranged and selected in terms of size in such a way that the usable inflow area of catalyst is preferably at least 60% of the inner cross-sectional area of the offgas duct, more preferably at least 70%, even more preferably at least 80%.

In the case of circular offgas ducts or offgas pipelines, the gaps that arise in the edge region of the packing of the honeycomb body modules, unless they can be easily occupied with rectangular honeycomb body modules, are preferably not filled with specially tailored honeycomb bodies, but closed by blind plates. This has the advantage that, when exchanging spent honeycomb bodies, only standardized honeycomb bodies have to be exchanged and no special adjustments are required.

When using offgas pipelines, it is preferably also possible to use individual larger honeycomb bodies adapted to the pipeline cross section with a circular inflow cross section, several of which may also be arranged in succession in flow direction in a preferred configuration. In this case, it is then unnecessary to combine several honeycomb bodies parallel to one another to form honeycomb body modules.

In preferred embodiments, the honeycomb bodies or honeycomb body modules are arranged in several layers offset along the longitudinal axis in flow direction of the offgas. The honeycomb bodies or honeycomb body modules are preferably arranged in 2 to 5 layers, more preferably in 2 to 3 layers. A margin is preferably provided between the layers, i.e. between the end faces of the honeycomb bodies or honeycomb body modules, preferably in the range from 3 to 30 mm, preferably 4 to 20 mm. The margin can enable intermediate, in particular radial, mixing of the gas flow emerging from a first layer of the honeycomb bodies or honeycomb body modules. Furthermore, it is possible to prevent any possible slip of unreacted reducing agent and/or of the as yet incompletely oxidized reaction products thereof from propagating from the first layer of the honeycomb bodies into a subsequent, second layer of the honeycomb bodies.

The reducing agents for NOₓ and optionally N₂O are preferably supplied and distributed via a manifold pipeline system having a multitude of openings or nozzles, disposed in the offgas duct or in the offgas conduit upstream of the respective catalyst bed in flow direction, preferably upstream of the packing of the catalyst honeycombs as honeycomb bodies or honeycomb body modules.

The distributor tubes are preferably designed in the form of grids, or in the form of concentrically connected circles, which extend as far as possible over the cross-sectional area of the offgas duct or the inflow area of the catalyst bed.

The specific design and dimensioning of these distributors, including suitable exit nozzles, is part of specialist knowledge in catalytic offgas cleaning technology and is widely employed, for example, in offgas treatment for coal-fired power plants.

### NH₃ Oxidation Catalyst

NH₃ oxidation catalysts are known to those skilled in the art.

The NH₃ oxidation catalyst is preferably free of platinum group metals, preferably free of precious metals.

What is meant by “free of platinum group metals” for the purposes of the description is that essentially no metal of the platinum group (i.e. Ru, Rh, Pd, Os, Ir, Pt) is present. However, analytically detectable minimal traces of platinum group metals are possible. What is meant by “free of precious metals” for the purposes of the description is that essentially no precious metal is present. However, analytically detectable minimal traces of precious metal are possible.

The NH₃ oxidation catalyst is preferably an iron-or copper-laden zeolite; preferably an iron-or copper-laden zeolite of the MFI, BEA, FER, MOR, FAU, AEI and/or MEL structure type (referred to hereinafter as “NH₃ oxidation-active iron-or copper-laden zeolite catalyst”).

Preferred platinum group metal-free NH₃ oxidation catalysts are selected from transition metal oxides (for example of Fe, Mn, Cu, Cr, Co, Ni . . . ) , metal-laden zeolites, described, for example, in Handbook of Heterogeneous Catalysis, Wiley-VCH, edited by Ertl, Knötzinger, Schüth, Weitkamp, 2nd Ed. 2008, Volume 5, Chapter 11.5 “Solid Catalysts for the Oxidation of Volatile Organic Compounds”.

Preferred NH₃ oxidation catalysts include
cobalt catalysts; especially Co₃O₄; Co₃O₄-derived mixed oxides (Co_{3-y}M_{y}O₄) that preferably crystallize like Co₃O₄ in the spinel structure, where M is preferably selected from Zn, Cu, Fe, Mn and V; cobalt-laden zeolites, preferably of the MFI, BEA, FER, MOR, FAU, CHA or AFI structure type;
manganese catalysts; especially Mn_{Ox} with x=1-2; MnOₓ-derived mixed oxides (Mn_{x-y}M_{y}Oₓ) where M is preferably selected from Zn, Cu, Fe and Mn; manganese-laden zeolites, preferably of the MFI, BEA, FER, MOR, FAU, CHA or AFI structure type;
copper catalysts; especially CuOₓ with x=0.5-1; CuOₓ-derived mixed oxides (Cu_{x-y}M_{y}Oₓ) where M is preferably selected from Zn, Co, Fe and Mn; copper-laden zeolites, preferably of the MFI, BEA, FER, MOR, FAU, CHA, AFI structure type;
silver catalysts; especially in supported form, preferably supported on Al₂O₃, TiO₂, or SiO₂, more preferably, for example, X% Ag/TiO₂, X% Ag/Al₂O₃, or X% Ag/SiO₂, in each case with X=1-10.

In preferred embodiments, the apparatus of the invention contains no further NH₃ oxidation catalyst aside from the iron-or copper-laden zeolite.

In preferred embodiments, the NH₃ oxidation catalyst, preferably the NH₃ oxidation-active, iron-laden zeolite catalyst, has a molar ratio of iron to zeolitic aluminum n(Fe)/n(Al) of less than 0.50 to greater than 0.05; preferably less than 0.40 to greater than 0.05, more preferably less than 0.25 to greater than 0.05, even more preferably less than 0.15 to greater than 0.05.

In preferred embodiments, the NH₃ oxidation catalyst, preferably the NH₃ oxidation-active, copper-laden zeolite catalyst, has a molar ratio of copper to zeolitic aluminum n(Cu)/n(Al) of less than 1.00 to greater than 0.10; preferably less than 0.80 to greater than 0.10, more preferably less than 0.50 to greater than 0.10, even more preferably less than 0.30 to greater than 0.10.

It has thus been found that, surprisingly, iron-or copper-laden zeolites in which only some of the potentially available cation sites are occupied with Fe or Cu ions, such that the residual cation sites are essentially satisfied by protons, have a significantly increased activity for the oxidation of NH₃ with free oxygen.

The ratio of iron or copper to zeolitic aluminum can be adjusted by selecting the Al content in the synthesis of the zeolitic material, in particular via the proportions of the chosen Si and Al starting materials, and also by later loading with iron or copper ions.

In the synthesis of zeolites, the chosen Si and Al starting materials are usually heated in alkaline solution, often under elevated pressure, which results in occurrence of crystallization to give the microporous aluminosilicates formed from three-dimensionally catenated AlO₂ and SiO₂ units, the zeolites. By controlled choice of the synthesis conditions, for example also by adding structure-directing reagents, e.g. organic cations, not only the Si/Al ratio and hence the Al content but also the structure type of the zeolite can be specifically adjusted or controlled. The synthesis methods are industrially established. Zeolites of different structure type with different Si/Al ratios and laden with different cations, for example in Na or NH₄ form, are commercially available.

Suitable methods known to those skilled in the art, for example liquid phase or solid-state ion exchange, can result in targeted exchange of the cations present in the zeolite, for example NH₄⁺, for other cations, e.g. iron or copper ions (J. Weitkamp, L. Puppe Catalysis and Zeolites—Fundamental and Applications Springer-Verlag Berlin Heidelberg New York, 1999 or Kucherov, A. V. Slinkin, A. A.: Solid state reactions as method of introducing transition metals cations into high-silica zeolites, Russ. Chem. Rev. 1992, vol. 61, no. 9, p. 925-943). If all negative charges generated by the AlO₂ units have been compensated for by cations, what is called the exchange level is 100%.

The exact Al content of the present zeolitic material or of the shaped catalyst bodies produced therefrom, and likewise the Fe content, as is well known, can be determined by X-ray fluorescence analysis (XRF). This is appropriately done in accordance with DIN EN 169-2 (section 5) after determination of ignition loss and after a lithium tetraborate digestion.

If the intention is to determine the Al content of the parent zeolitic material subsequently on the finished shaped body, it should be noted that the shaped body may also contain Al-based binder components which cannot be distinguished from zeolitic Al by XRF. In this case, an additional study of the shaped bodies is required, for example by means of ²⁷Al solid-state NMR which allows a distinction between the Al bound in the zeolite structure and extra-lattice Al. Those skilled in the art will be familiar with details of the fundamentals, implementation and evaluation of such studies (J. Weitkamp, L. Puppe Catalysis and Zeolites—Fundamentals and Applications, Springer-Verlag Berlin Heidelberg New York, 1999, Chapter 4.2 (NMR Spectroscopy; especially sections 4.2.4.1 (²⁹Si MAS NMR Spectroscopy of SiO₄ Tetrahedra in the Zeolite Framework) and 4.3.4.2 (²⁷Al NMR Spectroscopy of Framework and Non-Framework Aluminum in Zeolites)).

The NH₃ oxidation catalyst, preferably the NH₃ oxidation-active iron-laden zeolite catalyst, preferably has a total iron content (reported as mass content of Fe₂O₃) of less than 10.0% by weight to greater than 2.0% by weight, preferably of less than 7.0% by weight to greater than 2.0% by weight, more preferably of less than 5.0% by weight to greater than 2.0% by weight, and even more preferably of less than 4.0% by weight to greater than 2.0% by weight.

The NH₃ oxidation catalyst, preferably the NH₃ oxidation-active copper-laden zeolite catalyst, preferably has a total copper content (reported as mass content of Cu₂O) of less than 9.0% by weight to greater than 1.5% by weight, preferably of less than 6.5% by weight to greater than 1.5% by weight, more preferably of less than 4.5% by weight to greater than 1.5% by weight, and even more preferably of less than 3.5% by weight to greater than 1.5% by weight.

In preferred embodiments, the NH₃ oxidation catalyst, preferably the NH₃ oxidation-active iron-or copper-laden zeolite catalyst, is configured for selective oxidation of NH₃ with O₂ to N₂ and H₂O, and, introduced in the form of a particulate bed, the particles of which have an equivalent diameter of 3.5 to 5.5 mm, which is defined as the diameter of a spherical particle of equal volume, and where the ratio of the outer geometrically detectable surface area of the particles to the volume of the particulate bed is 1000 m²/m³ to 1500 m²/m³, in an amount of 8.0±0.5 ml in an isothermally operated tubular reactor with axial flow having an internal diameter of 20±3 mm, contacted with a volume flow rate of a gas mixture consisting of 500±50 ppmv of NH₃, 2.5±0.1% by volume of O₂ and 0.30±0.05% by volume of H₂O in N₂ at a space velocity based on standard conditions (0 °C; 1.01325 bara) of 10 000±500 h⁻¹, a total pressure of 6±0.5 bara and a temperature of 380 C±5 K, brings about an NH₃ conversion of at least 50%, preferably at least 60%, more preferably at least 70%, even more preferably at least 80%, in particular at least 90%.

In preferred embodiments, the N₂O decomposition catalyst and/or the N₂O reduction catalyst and/or the NOₓ reduction catalyst and/or the NH₃ oxidation catalyst independently have a honeycomb monolithic structure.

In preferred embodiments, the N₂O decomposition catalyst and/or the N₂O reduction catalyst and/or the NOₓ reduction catalyst and/or the NH₃ oxidation catalyst independently have a honeycomb monolithic structure.

In preferred embodiments, the NH₃ oxidation catalyst and the N₂O decomposition catalyst are made from the same material.

In preferred embodiments, the NH₃ oxidation catalyst and the N₂O reduction catalyst are made from the same material.

In preferred embodiments, the NH₃ oxidation catalyst and the NOₓ reduction catalyst are made from the same material.

In preferred embodiments, the NH₃ oxidation catalyst, the NOₓ reduction catalyst and the N₂O decomposition catalyst are made from the same material.

### Step (a)

In step (a) of the method of the invention, NH₃ is combusted to operate a firing system, preferably to drive an internal combustion engine, to drive a gas turbine, or to operate a furnace for cracking of NH₃ to N₂ and H₂. The combustion generates an offgas comprising N₂, H₂O, NOₓ and N₂O. The offgas leaves the firing system, preferably the internal combustion engine, the gas turbine or the furnace, and is then fed to step (b) of the method of the invention.

In step (a) or in the internal combustion engine configured in accordance with the invention, the combustion of NH₃, i.e. the oxidation of NH₃ with O₂ (or the mixture of NH₃ with a further combustible gas, for example H₂, CH₄, etc.), is preferably not over a catalyst, i.e. combustion is not performed in the presence of a heterogeneous catalyst.

In preferred embodiments, NH₃ is combusted in step (a) in a mixture with one or more further combustible gases, meaning that both NH₃ and at least one further combustible gas are oxidized with O₂.

In preferred embodiments, the further combustible gas is a fossil fuel.

In preferred embodiments, the further combustible gas is selected from hydrocarbons and hydrocarbon mixtures, preferably methane, ethane, propane, butane, natural gas, gasoline and/or diesel.

In preferred embodiments, the further combustible gas is selected from alcohols, preferably methanol and/or ethanol.

In other preferred embodiments, the further combustible gas is H₂.

More preferably, the further combustible gas is H₂which is formed by thermal and/or catalytic cracking of NH₃. It is preferably the integrated combustion of NH₃ with O₂ that supplies the energy for the cracking. Preferably, in step (a), the combustion of NH₃ is therefore integrated in a process for thermal and/or catalytic cracking of NH₃ to N₂ and H₂.

In preferred embodiments, NH₃ is combusted in step (a) to drive a gas turbine in combination with a steam turbine.

Combustion in the gas turbine is preferably effected with air or oxygen as a single-stage combustion (i) of pure NH₃; or (ii) of a mixture comprising NH₃ and hydrocarbon, preferably natural gas or CH₄; or (iii) of a mixture comprising NH₃ and H₂.

The air ratio λ (combustion air ratio) expresses the actual mass of air available relative to the minimum necessary mass of air that is required theoretically for stoichiometrically complete combustion. Depending on the composition of the fuel, the combustion in step (a) is preferably effected at different air ratios λ.

If the fuel consists essentially of pure NH₃ or the proportion of NH₃ in the fuel is at least 90% by volume based on the total volume of the fuel, the combustion is preferably effected at an air ratio λ in the range from 1.0 to 1.5, more preferably 1.1 to 1.4, even more preferably 1.1 to 1.3.

If the fuel consists essentially of mixtures of NH₃ and CH₄ and the proportion of CH₄ is not more than 50 % by volume based on the total volume of the fuel, the combustion is preferably effected at an air ratio λ in the range from 1.5 to 2.5, more preferably 1.6 to 2.4, even more preferably 1.7 to 2.3.

If the fuel consists essentially of mixtures of NH₃ and CH₄ and the proportion of CH₄ is more than 50 % by volume based on the total volume of the fuel, the combustion is preferably effected at an air ratio λ in the range from 2.0 to 3.0, more preferably 2.1 to 2.9, even more preferably 2.2 to 2.8.

If the fuel consists essentially of mixtures of NH₃ and H₂ and the proportion of H₂ is not more than 50 % by volume based on the total volume of the fuel, the combustion is preferably effected at an air ratio λ in the range from 2.0 to 3.0, more preferably 2.1 to 2.9, even more preferably 2.2 to 2.8.

If the fuel consists essentially of mixtures of NH₃ and H₂ and the proportion of H₂ is more than 50 % by volume based on the total volume of the fuel, the combustion is preferably effected at an air ratio λ in the range from 2.5 to 3.5, more preferably 2.6 to 3.4, even more preferably 2.7 to 3.3.

The combustion in step (a) preferably produces an offgas at a temperature in the range from 1000 to 1500 °C prior to entry into the turbine.

The combustion in step (a) preferably produces an offgas preferably at a pressure in the range from 10 to 32 bar prior to entry into the turbine.

The combustion in step (a) preferably produces an offgas having preferably a degree of oxidation (n(NO₂)/(n(NO)+n(NO₂))) of NOₓ of at most 5.0%, more preferably at most 4.0%, even more preferably at most 3.0%, most preferably at most 2.0% and in particular at most 1.0%, possibly even at most 0.5% prior to entry into the turbine.

According to the invention, combustion is preferably effected in one stage, i.e. preferably neither as a lean premixed combustion nor as a staged rich-lean combustion. Single-stage combustion enables optimized operation and simplifies the construction of the gas turbine system. According to the invention, combustion is effected with a comparatively small air surplus λ and hence consciously accepts elevated concentrations of NOₓ. The balance of NO₂ and NO, i.e. the degree of oxidation of NOₓ, at the high temperatures of combustion (e.g. >1500 °C) is to the NO side; consequently, virtually the entire amount of NOₓ is present as NO in the hot combustion offgas, i.e. at most small amounts of NO₂ are present.

The gas turbine of the invention preferably has an annular combustion chamber. There is preferably an arrangement of several burners in a ring around a shaft upstream of the turbine. A secondary air flow is directed around these burners and mixed upstream of the turbine. Fuel premixing, complete combustion and mixing then have to take place over short distances.

Because of the high volume flow rates in the gas turbines, offgas cleaning can be very complex in some cases. Therefore, in conventional methods of operating gas turbines, attempts are frequently made to comply with pollutant emissions directly at the site of formation by combustion technology measures. A comparatively high air surplus λ results in superstoichiometric combustion, and so complete combustion can be assumed. Because of the limited thermal durability of the gas turbine, the air surplus λ in stationary single-shaft machines typically cannot fall below λ values of 2.5 to 3.5.

In conventional natural gas-operated gas turbines, NOₓ is formed from atmospheric nitrogen (thermal NOₓ) at sites of high temperature with sufficiently long reaction time. In NH₃-operated gas turbines, the majority of the NOₓ is formed from the fuel (fuel NOₓ). Temperature and dwell time in hot zones therefore have to be reduced in order to suppress the formation of NOₓ.

Cooling of the flames by addition of water or steam to the fuel has been found to be effective (wet denoxing). At a fuel/water vapor mixing ratio of 1:1, the NOₓ content of is reduced by 80%. However, the need to use costly demineralized water in order to avoid scaling and corrosion of the turbine blades leads to higher operating costs in the case of this measure.

Newer burners utilize intensive premixing of superstoichiometric air volume and fuel to avoid local excess temperatures in the combustion as a result of differences in fuel concentration (dry denoxing). High value is placed here on a uniform flow regime, in order, for example, to avoid backflow regions where a long dwell time of the air could arise. Different combustion zone is arranged in succession, such as rich-lean zones, have likewise brought good results.

In general, the lower calorific value of the NH₃ vs. CH₄ fuel combined with a lower flame temperature can be assumed to result in a lower thermal load on the turbine. However, the reduced flame temperature additionally promotes formation of NOₓ and N₂O.

Preferably, the offgas produced by the combustion in step (a) is subsequently expanded in a gas turbine.

Preferably, the offgas at the outlet from the gas turbine is at a temperature in the range from 450 to 670 °C.

Preferably, the offgas at the outlet from the gas turbine is at a pressure greater than atmospheric pressure, i.e. ≥1.0 bara, but at most 1.2 bara, more preferably at most 1.1 bara.

Preferably, the offgas at the outlet from the gas turbine has an NOₓ content in the range from 500 to 3000 ppmv.

Preferably, the offgas at the outlet from the gas turbine has an O₂ content in the range of 1.0-6.0% by volume.

Preferably, the offgas at the outlet from the gas turbine has an H₂O content in the range of 20-30% by volume.

Preferably, the offgas at the outlet from the gas turbine has an N₂O content of at most 500 ppmv, more preferably at most 200 ppmv, even more preferably at most 100 ppmv.

Preferably, the offgas at the outlet from the gas turbine has an N₂O content of at least 5 ppmv, more preferably at least 20 ppmv, even more preferably at least 50 ppmv.

Preferably, the offgas at the outlet from the gas turbine has an NH₃ content of at most 800 ppmv, more preferably at most 500 ppmv, even more preferably at most 250 ppmv.

Preferably, the offgas at the outlet from the gas turbine has an NH₃ content of at least 10 ppmv, more preferably at least 50 ppmv, even more preferably at least 100 ppmv.

Preferably, the offgas at the outlet from the gas turbine has an degree of oxidation (n(NO₂)/(n(NO)+n(NO₂))) of NOₓ of at most 10%, more preferably at most 9.0%, even more preferably at most 8.0%, most preferably at most 7.0% and in particular at most 6.0%, possibly even at most 5.0%.

In preferred embodiments, NH₃ is combusted in step (a) in a mixture with CH₄ and the offgas therefore additionally comprises CO and CO₂ and preferably also HCN.

Preferably, the offgas at the outlet from the gas turbine has an HCN content of at least 5 ppmv, more preferably at least 10 ppmv, even more preferably at least 50 ppmv.

Preferably, the offgas at the outlet from the gas turbine has an HCN content of at most 1000 ppmv, more preferably at most 500 ppmv, even more preferably at most 200 ppmv, most preferably at most 100 ppmv.

In particularly preferred embodiments, step (a) of the method of the invention comprises the component steps of:
(a₁) thermally and/or catalytically cracking NH₃ to produce a cracking gas comprising N₂, H₂ and optionally residual NH₃;
(a₂) optionally mixing the cracking gas with further NH₃ to produce a mixture comprising H₂ and NH₃;
(a₃) combusting the cracking gas or the mixture.

Suitable methods of thermal and/or catalytic cracking of NH₃ to N₂ and H₂ are known to a person skilled in the art. Suitable catalysts for the cracking of NH₃ to N₂ and H₂ are, for example, Al₂O₃- or SiO₂-supported Ru, MgAl₂O₄-supported Fe, Co, Ni, Cu or Ru, or Co₃Mo₃N (A. Boisen et al., Journal of Catalysis 230 (2005) 309-312; I. Lucentini et al., Ind. Eng. Chem. Res. 2021, 60, 18560-18611; H.J. Lee et al., Catalysts 2022, 12, 1203).

If the cracking in component step (a₁) does not proceed to completion, the cracking gas (i.e. the cracking product) will additionally still contain residual unconverted NH₃ as well as N₂ and H₂. In this way, a mixture of NH₃ and H₂ is then already obtained, which can either be directly combusted as such or first enriched with further NH₃ in optional component step (a₂).

If the cracking in component step (a₁) proceeds to completion, the required amount of NH₃ still has to be added to the cracking gas in step (a₂).

Preferably, component step (al) and optionally component step (a₂) establish a mixing ratio of NH₃ and H₂ which is optimized with regard to the subsequent combustion. The proportion of H₂ is preferably at most 80 mol %, more preferably at most 70 mol %, even more preferably at most 60 mol %, most preferably at most 50 mol %, and in particular at most 40 mol %. The proportion of H₂ is preferably at least 10 mol %, more preferably at least 20 mol %, even more preferably at least 30 mol %, most preferably at least 40 mol %, and in particular at least 50 mol %.

In particularly preferred embodiments, the molar ratio of H₂:NH₃ in the mixture is in the range from 45:55 to 90:10, preferably 50:50 to 85:15, more preferably 55:45 to 80:20, even more preferably 60:40 to 75:25, most preferably 65:35 to 70:30.

In component step (a₃), the mixture is combusted, typically with air. In preferred embodiments, the air ratio ) for the combustion in component step (a₃) is in the range from 0.9 to 1.7, more preferably 1.0 to 1.6, even more preferably 1.1 to 1.5, most preferably 1.2 to 1.4. The air ratio λ (i.e. the combustion air ratio) indicates the mass ratio of air to fuel relative to the stoichiometrically ideal ratio for a theoretically complete combustion process. It is defined as that ratio of air to fuel which contains a sufficient mass of oxygen to achieve complete combustion of a given mass of fuel (cf. e.g. K. Soman, Thermal Engineering, PHI, 2011, page 224, no. 5.4.2). In principle, the ratio can be expressed in terms of mass or molar amount (cf. e.g. P. Majumdar, Design of Thermal Energy Systems, Wiley 2021, page 66, No. 2.13.5.2). For the purposes of the description, the ratio is based on mass. If not air but another oxygen-containing gas is used for a combustion operation, “air” should, strictly speaking, be replaced by “oxygen carrier”. However, the λ parameter is still used in the above definition.

In preferred embodiments, the equivalence ratio NH₃/H₂ (Φ) (not to be confused with the reciprocal of the air ratio 1/λ) is in the range from 0.55 to 1.40, more preferably 1.05 to 1.20.

In other preferred embodiments, NH₃ is combusted alone in step (a), i.e. NH₃ is the only combustible gas that is combusted.

In preferred embodiments, the firing system, preferably the internal combustion engine, is mounted in a vehicle and serves to move the vehicle. The vehicle is preferably a ship. The vehicle is preferably a road vehicle; preferably selected from commercial vehicles, trucks and passenger cars; or a rail vehicle.

In other preferred embodiments, the firing system, preferably the gas turbine, is part of a power plant. The power plant preferably generates electrical power and/or district heating.

In further preferred embodiments, the firing system, preferably the furnace for cracking of NH₃ to N₂ and H₂, is integrated into a system for thermal and/or catalytic cracking of NH₃ to N₂ and H₂. The combustion of NH₃ is then integrated into a process for thermal and/or catalytic cracking of NH₃ to N₂ and H₂.

In preferred embodiments, the offgas has an NOₓ content greater than the N₂O content. The NOₓ content is preferably at least twice as high, more preferably at least three times as high, even more preferably at least four times as high, most preferably at least seven times as high and in particular at least ten times as high as the N₂O content. Preferably, the molar ratio of NOₓ:N₂O is more than 10:1, more preferably at least 20:1, even more preferably at least 30:1, most preferably at least 40:1, and in particular at least 50:1.

In preferred embodiments, the offgas has an NO content greater than the N₂O content. The NO content is preferably at least twice as high, more preferably at least three times as high, even more preferably at least four times as high, most preferably at least seven times as high and in particular at least ten times as high as the N₂O content.

In preferred embodiments, the offgas has an NO₂ content greater than the N₂O content. The NO₂ content is preferably at least twice as high, more preferably at least three times as high, even more preferably at least four times as high, most preferably at least seven times as high and in particular at least ten times as high as the N₂O content.

Preferably, the offgas has an NOₓ content of at least 10 ppmv, preferably at least 20 ppmv, more preferably at least 30 ppmv, even more preferably at least 40 ppmv, and in particular at least 50 ppmv.

Preferably, the offgas has an NOₓ content of at least 75 ppmv, preferably at least 100 ppmv, more preferably at least 150 ppmv, even more preferably at least 200 ppmv, and in particular at least 250 ppmv.

Preferably, the offgas has an NOₓ content of at least 500 ppmv, preferably at least 1000 ppmv, more preferably at least 2000 ppmv, even more preferably at least 3000 ppmv, and in particular at least 3500 ppmv.

Preferably, the offgas has an N₂O content of at least 10 ppmv, preferably at least 20 ppmv, more preferably at least 30 ppmv, even more preferably at least 40 ppmv, and in particular at least 50 ppmv.

Preferably, the offgas has an N₂O content of at least 75 ppmv, preferably at least 100 ppmv, more preferably at least 150 ppmv, even more preferably at least 200 ppmv, and in particular at least 250 ppmv.

Preferred offgases have an NOₓ content in the range from 1500 to 3000 ppmv, preferably 2000 to 3000 ppmv, and an N₂O content in the range from 20 to 100 ppmv.

In other preferred embodiments, the offgas has an H₂O content of more than 4.0% by volume; preferably at least 5.0% by volume, more preferably at least 6.0% by volume, even more preferably at least 7.0% by volume, most preferably at least 8.0% by volume, and in particular at least 9.0% by volume.

In further preferred embodiments, the offgas has an H₂O content of at least 10% by volume; preferably at least 12% by volume, more preferably at least 14% by volume, even more preferably at least 16% by volume, most preferably at least 18% by volume, and in particular at least 20% by volume.

In preferred embodiments, the offgas has an H₂O content in the region of 10±8% by volume; preferably in the region of 10±7% by volume, more preferably in the region of 10±6% by volume, even more preferably in the region of 10±5% by volume, most preferably in the region of 10±4% by volume, and especially in the region of 10±3% by volume.

In preferred embodiments, the offgas has an H₂O content in the region of 15±8% by volume; preferably in the region of 15±7% by volume, more preferably in the region of 15±6% by volume, even more preferably in the region of 15±5% by volume, most preferably in the region of 15+4% by volume, and especially in the region of 15±3% by volume.

In preferred embodiments, the offgas has an H₂O content in the region of 20±8% by volume; preferably in the region of 20±7% by volume, more preferably in the region of 20±6% by volume, even more preferably in the region of 20±5% by volume, most preferably in the region of 20+4% by volume, and especially in the region of 20±3% by volume.

In preferred embodiments, the offgas has an H₂O content in the region of 25±8% by volume; preferably in the region of 25±7% by volume, more preferably in the region of 25±6% by volume, even more preferably in the region of 25±5% by volume, most preferably in the region of 25+4% by volume, and especially in the region of 25±3% by volume.

In preferred embodiments, the offgas has an H₂O content in the region of 30±8% by volume; preferably in the region of 30±7% by volume, more preferably in the region of 30±6% by volume, even more preferably in the region of 30±5% by volume, most preferably in the region of 30±4% by volume, and especially in the region of 30±3% by volume.

Preferably, the offgas has an N₂ content of at most 95% by volume, preferably at most 90% by volume, more preferably at most 85% by volume, even more preferably at most 80% by volume, most preferably at most 75% by volume, and in particular at most 70% by volume.

Preferably, the offgas has an N₂ content of at least 40% by volume; preferably at least 50% by volume, more preferably at least 60% by volume, even more preferably at least 70% by volume, most preferably at least 80% by volume, and in particular at least 90% by volume.

Preferably, the offgas comprises further gaseous components; preferably selected from the group consisting of O₂, CO, CO₂, NH₃, CH₄ and mixtures thereof.

Preferably, the offgas on departure from the firing system, preferably the internal combustion engine, the gas turbine or the furnace, is at a temperature of at least 500 °C, more preferably at least 600 °C, even more preferably at least 700 °C, most preferably at least 800 °C, and in particular at least 900°C.

Preferably, the offgas on departure from the firing system, preferably the internal combustion engine, the gas turbine or the furnace, is at a temperature of at most 1100 °C, more preferably at most 1000 °C, even more preferably at most 900 °C, most preferably at most 800 °C, and in particular at most 700 °C.

Preferably, the offgas, after leaving the firing system, is cooled over the course of the method of the invention, although steps (c₁) and/or (c₂) and/or (d) can introduce new heat.

### Preferred Variants of Combinations of Steps (c) and (d):

In preferred embodiments, steps (c₁) and/or (c₂) and/or (d) of the method of the invention are performed at different temperatures, i.e. at different temperature levels, where a step conducted earlier or upstream in flow direction of the offgas preferably proceeds at a higher temperature than a step performed subsequently or downstream in flow direction of the offgas.

Preferably, the offgas on departure from the firing system, preferably the internal combustion engine, the gas turbine or the furnace, is at a pressure of at most 1.5 bar; preferably atmospheric pressure.

Preferably, the offgas on departure from the firing system, preferably the internal combustion engine, the gas turbine or the furnace, has a degree of oxidation of NOₓ of at least 10%, more preferably at least 20%, even more preferably at least 30%, most preferably at least 40%, and in particular at least 50%.

Preferably, the offgas on departure from the firing system, preferably the internal combustion engine, the gas turbine or the furnace, has a degree of oxidation of NOₓ of at most 90%, more preferably at most 80%, even more preferably at most 70%, most preferably at most 60%, and in particular at most 50%.

Preferably, the offgas on departure from the firing system, preferably the internal combustion engine, the gas turbine or the furnace, has an O₂ content of less than 2.0% by volume.

Preferably, the offgas on departure from the firing system, preferably the internal combustion engine, the gas turbine or the furnace, has an O₂ content of more than 4.0% by volume.

In step (b) of the method of the invention, the offgas which has left the firing system, preferably the internal combustion engine, the gas turbine or the furnace, is transferred to an offgas treatment system.

This can be effected, for example, by means of pipelines connecting the outlet of the firing system, preferably the internal combustion engine, the gas turbine or the furnace, to the inlet of the offgas treatment system. Since the method of the invention is preferably performed at atmospheric pressure, no special requirements are typically placed on such pipelines with regard to possible compressive stress.

However, the pipelines should withstand the temperatures of the offgas on departure from the firing system, preferably the internal combustion engine, the gas turbine or the furnace, or on entry into the offgas treatment system.

In preferred embodiments, the offgas temperature is measured at the outlet of the firing system, preferably the internal combustion engine, the gas turbine or the furnace, and optionally modified with suitable devices in order that the offgas on entry into the offgas treatment system has an optimized temperature under the given conditions for performance of steps (c) and (d) of the method of the invention within the offgas treatment system. The optimized temperature depends in particular on the type of catalyst materials used for the N₂O decomposition catalyst and/or N₂O reduction catalyst and the NOₓ reduction catalyst. The optimized temperature is guided by the chosen configuration of steps (c) and (d), i.e. the type and sequence of the individual process steps for N₂O reduction and NOₓ reduction and in particular the type of catalyst materials used for the N₂O decomposition catalyst and/or N₂O reduction catalyst and the NOₓ reduction catalyst.

Suitable devices for altering the temperature of the offgas are known to a skilled person and include in particular heat exchangers, which may be configured, for example, as plate heat exchangers or tube heat exchangers.

Preferably, at least one heat exchanger in which the offgas is cooled is disposed downstream of the gas turbine and upstream of the offgas treatment system in flow direction of the offgas.

Preferably, the offgas temperature at the outlet from the heat exchanger is at most 550 °C, more preferably at most 525 °C, even more preferably at most 500 °C.

Preferably, the offgas temperature at the outlet from the heat exchanger is at least 400 °C, more preferably at least 425 °C, even more preferably at least 450 °C.

In order to avoid heat losses, it may be preferable in accordance with the invention to choose as short as possible a distance from the outlet of the firing system, preferably the internal combustion engine, the gas turbine or the furnace, to the inlet into the offgas treatment system, and in this way to achieve a compact design.

However, depending on the nature of the catalysts used, the steps may not be completely separable from each other, either locally or in time. If a catalyst used is simultaneously suitable for catalysis of two or more of steps (c₁), (c₂) and (d), these steps may proceed simultaneously and/or sequentially. In flow direction of the offgas, it is possible for that purpose to consider individual segments of one and the same catalyst through which the offgas flows successively and in which different reactions may dominate. Which reaction is dominant in which section depends in particular on the respective reaction kinetics, the local temperature and the local concentrations of the reactants, possibly including the concentration of reducing agent and possibly including the concentration of cocatalytically active species.

The offgas treatment system of the invention is used in particular for performance of steps (c) and (d) of the method of the invention. However, it is also possible that further steps and chemical reactions are conducted within the offgas treatment system in addition to steps (c) and (d).

This preferably relates to the installation of a catalyst bed disposed downstream in flow direction of the offgas for oxidation of incompletely converted reducing agents or the as yet incompletely oxidized reaction products thereof, i.e., for example, for oxidation of NH₃ (NH₃ oxidation catalyst) or CO (CO oxidation catalyst; when hydrocarbons are used as reducing agents). In such embodiments, the offgas is preferably cooled before it is introduced into the downstream catalyst bed, i.e. the oxidation of NH₃ and/or CO is preferably effected at a lower temperature than steps (c) and (d).

In the performance of the steps (c) and (d) of the method of the invention, according to the invention, there are different preferred variants of the process regime, which can differ from each other with regard to the sequence of the reactions that proceed, the catalysts used, the reducing agents used, the space velocities and other reaction conditions.

In preferred embodiments, these reactions are conducted in a common reaction zone (catalyst bed), which is equipped upstream with an apparatus for metering reducing agent into the offgas.

In other preferred embodiments, these reactions are conducted in two separate reaction zones (catalyst beds) arranged in succession, of which preferably at least one reaction zone, preferably both reaction zones, is/are independently equipped upstream with an apparatus for metering reducing agent into the offgas. In that case, the offgas flows first through the first reaction zone and subsequently through the second reaction zone.

Particularly preferred variants/embodiments include
[a] (c₂) the chemical reduction of N₂O with NH₃ and (d) the chemical reduction of NOₓ with NH₃, preferably collectively in one reaction zone;
[b] (c₂) the chemical reduction of N₂O with hydrocarbon (CH₄, natural gas, etc.) and (d) the chemical reduction of NOₓ with NH₃, preferably collectively in one reaction zone;
[c] (c₁) the decomposition of N₂O and (d) the chemical reduction of NOₓ with NH₃, preferably collectively in one reaction zone;
[d] (c₁) the decomposition of N₂O and (c₂) the chemical reduction of N₂O with NH₃ and (d) the chemical reduction of NOₓ with NH₃, preferably collectively in one reaction zone;
[e] (c₁) the decomposition of N₂O and (c₂) the chemical reduction of N₂O with hydrocarbon (CH₄, natural gas, etc.) and (d) the chemical reduction of NOₓ with NH₃, preferably collectively in one reaction zone;
[f] (c₁) the decomposition of N₂O, preferably in a first reaction zone; and subsequently (d) the chemical reduction of NOₓ with NH₃, preferably in a second reaction zone;
[g] (c₁) the incomplete decomposition of N₂O, preferably in a first reaction zone; and subsequently (c₂) the chemical reduction of residual N₂O with NH₃ and (d) the chemical reduction of NOₓ with NH₃, preferably in a second reaction zone;
[h] (c₁) the incomplete decomposition of N₂O, preferably in a first reaction zone; and subsequently (c₂) the chemical reduction of residual N₂O with hydrocarbon (CH₄, natural gas, etc.) and (d) the chemical reduction of NOₓ with NH₃, preferably in a second reaction zone;
[i] (c₁) the incomplete decomposition of N₂O, preferably in a first reaction zone; and subsequently (c₁*) the decomposition of residual N₂O and (d) the chemical reduction of NOₓ with NH₃, preferably in a second reaction zone;
[j] (c₁) the incomplete decomposition of N₂O, preferably in a first reaction zone; and then (c1*) the decomposition of residual N₂O and (c₂) the chemical reduction of residual N₂O with NH₃ (d) and the chemical reduction of NOₓ with NH₃, preferably in a second reaction zone;
[k] (c₁) the incomplete decomposition of N₂O, preferably in a first reaction zone; and then (c1*) the decomposition of residual N₂O and (c₂) the chemical reduction of residual N₂O with hydrocarbon (CH₄, natural gas, etc.) and (d) the chemical reduction of NOₓ with NH₃, preferably in a second reaction zone;
[;] (d) the incomplete chemical reduction of NOₓ, preferably in a first reaction zone; and subsequently (c₁) the decomposition of N₂O and (d*) the chemical reduction of residual NOₓ with NH₃, preferably in a second reaction zone;
[m] (d) the incomplete chemical reduction of NOₓ, preferably in a first reaction zone; and subsequently (c₁) the decomposition of N₂O and (c₂) the chemical reduction of N₂O with NH₃ and (d*) the chemical reduction of residual NOₓ with NH₃, preferably in a second reaction zone; or
[n] (d) the incomplete chemical reduction of NOₓ, preferably in a first reaction zone; and subsequently (c₁) the decomposition of N₂O and (c₂) the chemical reduction of N₂O with hydrocarbon (CH₄, natural gas, etc.) and (d*) the chemical reduction of residual NOₓ with NH₃, preferably in a second reaction zone.

This does not mean, however, that the reactions explicitly mentioned must be the only reactions that take place in the respective reaction zone. Depending on the catalyst used, it is instead preferred in accordance with the invention that, in addition, further reactions also take place simultaneously, which are not explicitly mentioned but can proceed in parallel. The reactions explicitly mentioned are therefore only those reactions that at least take place in the respective variant/embodiment.

If NOₓ, N₂O and NH₃ are present in a mixture and the catalyst used catalyzes both the chemical reduction of NOₓ with NH₃ and the chemical reduction of N₂O with NH₃, the chemical reduction of NOₓ with NH₃ is typically much faster than the chemical reduction of N₂O with NH₃. If the catalyst used additionally catalyzes the decomposition of N₂O, the decomposition of N₂O typically overlaps with the chemical reduction of N₂O with NH₃, where the extent of the chemical reduction of N₂O can be increased by increasing the amount of NH₃ metered in.

For the purposes of the description, “*” denotes a component method step that has previously been conducted only partially in a component method step of the same type, where the component method step identified by “*” then continues the component method step that has previously been conducted only partially, but possibly in a different reaction zone or a different catalyst bed. As with all other method steps, unless explicitly stated otherwise, the result achieved at the end of all component method steps is not quantified. If, for example, NOₓ is chemically incompletely reduced in a first component method step (d), the fact that component method step (d*) is subsequently conducted does not necessarily mean that, at the end of component method step (d*), the total amount of NOₓ must have been completely chemically reduced, i.e. to 0.0 ppmv. Instead, it is entirely possible that, at the end of component method step (d*), there is still a residual amount of NOₓ.

The offgas treatment system comprises at least one injection site for reducing agents. The offgas treatment system may comprise several injection sites for reducing agents.

The mode of introduction of the reducing agents into the stream of the offgas to be treated is freely configurable in accordance with the invention, provided that this is done upstream of the N₂O reduction catalyst or NOₓ reduction catalyst in flow direction. The reducing agent can be introduced in the form of a gas or else a liquid or aqueous solution that evaporates in the stream of the offgas to be treated. The feeding is effected by a suitable apparatus, for example an appropriate pressure valve or appropriately designed nozzles, which leads into a mixer for the stream of the offgas to be treated and the reducing agent supplied. When different reducing agents for NOₓ and N₂O are used, the supply and introduction into the offgas can be effected separately or together.

In the case of configuration of the catalyst beds as a packing of catalyst honeycombs or honeycomb body modules, the supply and distribution of the reducing agents for NOₓ and optionally N₂O to the one or more reaction zones (catalyst beds) is preferably effected via a manifold pipeline system having a multitude of openings or nozzles, disposed upstream of the respective reaction zone (catalyst bed) in flow direction of the offgas, i.e. upstream of the packing of the catalyst honeycombs or honeycomb modules.

The distributors are preferably designed in the form of grids, or concentrically connected circles, which extend as far as possible over the cross-sectional area of the offgas duct or the inflow area of the reaction zone (catalyst bed).

The specific design and dimensioning of these distributors, including suitable exit nozzles, is part of specialist knowledge in catalytic offgas cleaning technology and is widely employed, for example, in offgas treatment for coal-fired power plants.

The offgas treatment system of the invention may comprise a single reaction zone. In this case, the catalyst used in this single reaction zone serves as N₂O decomposition catalyst and/or N₂O reduction catalyst and as NOₓ reduction catalyst. In this case, the steps (c) and (d) of the method of the invention are effected essentially simultaneously within this reaction zone. However, it should be noted that the kinetics of the individual conversions can be quite different. For instance, depending on the catalyst material used, the chemical reduction of NOₓ with NH₃ as reducing agent can proceed much more quickly than the chemical reduction of N₂O with NH₃. Thus, if NOₓ and N₂O are in a mixture and NH₃ is fed in as reducing agent, different reactions will take place in the front section of the single reaction zone than in the rear section of the single reaction zone. In the front section, owing to the faster kinetics, the chemical reduction of NOₓ proceeds predominantly, and it is only in the rear section, once the majority of the NOₓ has been broken down, that the chemical reduction of N₂O proceeds.

Alternatively, the offgas treatment system may comprise several reaction zones, which is preferred in accordance with the invention. If several reaction zones are included, they are preferably in succession, such that the offgas flows through them one after another: first the first reaction zone and then the second reaction zone and, if appropriate, then the third reaction zone.

In preferred embodiments, the reaction zones are each spatially separated catalyst beds.

In preferred embodiments, the offgas undergoes the steps of the method of the invention in one of the following sequences:
(i) (a)→(b)→(c1)→(d); where step (c₁) preferably proceeds in a first reaction zone; and step (d) proceeds in a second reaction zone;
(ii) (a)→(b)→(d)→(c₂); where step (d) preferably proceeds in a first reaction zone; and step (c₂) proceeds in a second reaction zone;
(iii) (a)→(b)→(d)→(c₂)→(c₁); where step (d) preferably proceeds in a first reaction zone; step (c₂) proceeds in a second reaction zone; and step (c₁) proceeds in a third reaction zone;
(iv) (a)→(b)→(d)→(c₁)+(c₂); where step (d) preferably proceeds in a first reaction zone; and step (c₁) and step (c₂) proceed in a second reaction zone;
(v) (a)→(b)→(d)→(c₁); where step (d) preferably proceeds in a first reaction zone; and step (c₁) proceeds in a second reaction zone;
(vi) (a)→(b)→(c₁)+(d)→(d*); where preferably, step (c₁) and step (d) incompletely proceed in a first reaction zone; and the remainder of step (d*) proceeds in a second reaction zone;
(vii) (a)→(b)→(c₁)+(d)→(d*)+(c₁); where step (c₁) and step (d) incompletely preferably proceed in a first reaction zone; and step (c₂) and the remainder of step (d*) proceed in a second reaction zone;
(viii) (a)→(b)→(c₁)+(c₂)+(d)→(c1*)+(c₂*)+(d*); wherein step (c₁) incompletely and step (c₂) incompletely and step (d) incompletely preferably proceed in a first reaction zone which preferably does not contain a zeolitic material as catalyst; and the remainder of step (cl*) and the remainder of step (c2*) and the remainder of step (d*) proceed in a second reaction zone which preferably contains zeolitic material as catalyst;
(ix) (a)→(b)→(c₁)+(c₂)+(d)→(c1*)+(c2*)+(d*); wherein step (c₁) incompletely and step (c₂) incompletely and step (d) incompletely preferably proceed in a first reaction zone which preferably contains a zeolitic material as catalyst; and the remainder of step (c1*) and the remainder of step (c2*) and the remainder of step (d*) proceed in a second reaction zone which preferably contains an NOₓ-sensitive N₂O decomposition catalyst as catalyst;
(x) (a)→(b)→(c1)→(c1*)+(c₂)+(d); where step (c₁) incompletely preferably proceeds in a first reaction zone which preferably contains zeolitic material as catalyst; and the remainder of step (c1*) and step (c₂) and step (d) proceed in a second reaction zone which preferably contains zeolitic material as catalyst;
(xi) (a)→(b)→(c₁)→(c1*)+(c₂)+(d); where step (c₁) incompletely preferably proceeds in a first reaction zone which preferably contains an NOₓ-sensitive N₂O decomposition catalyst as catalyst; and the remainder of step (c1*) and step (c₂) and step (d) proceed in a second reaction zone which preferably contains zeolitic material as catalyst.

However, it is also possible that two or more reaction zones are implemented by a single catalyst bed. Two reaction zones on a shared catalyst bed can be formed in particular by a feed of reducing agent in the middle (or another position along the longitudinal extent) of the catalyst bed. There is then no reducing agent upstream of the feed point, such that steps (c₂) and (d) of the method of the invention cannot take place for lack of reducing agent. What then takes place upstream is then essentially the decomposition of N₂O in step (c₁) (first reaction zone). Downstream of the feed point, reducing agent is present, and so steps (c₂) and (d) of the method of the invention can take place, possibly overlapping with step (c₁) of the method of the invention (second reaction zone). In this case too, different reactions may occur in the front section of each reaction zone than in the rear section of each reaction zone, because of the different reaction kinetics; however, the first reaction zone and the second reaction zone will in any case differ from one another in that no chemical reduction of N₂O and also no chemical reduction of NOₓ takes place in the first reaction zone for lack of reducing agent.

In particularly preferred embodiments, the offgas treatment system comprises a first reaction zone and a second reaction zone. It is possible that further reaction zones are present.

In preferred embodiments, the first reaction zone and the second reaction zone are spatially separated from each other. In this case, they are preferably separate catalyst beds. In the case of spatial separation of the catalyst beds, it is possible to adjust the temperature of the second catalyst bed or the gas stream entering it by removal or supply of heat such that it is lower or higher than that of the first catalyst bed. The temperature of a single catalyst bed can appropriately be determined as the arithmetic mean of the temperature of the gas stream at the inlet and outlet from the catalyst bed.

In preferred embodiments, the temperature in the first reaction zone (in the first catalyst bed) is higher than the temperature in the second reaction zone (in the second catalyst bed).

Preferably, the temperature in the first reaction zone (in the first catalyst bed) is at least 450 °C, more preferably at least 500 °C, even more preferably at least 550 °C, most preferably at least 600 °C, and in particular at least 650 °C.

Preferably, the temperature in the second reaction zone (in the second catalyst bed) is at most 600 °C, more preferably at most 550 °C, even more preferably at most 500 °C, most preferably at most 450 °C, and in particular at most 400 °C.

Preferably, the temperature in the first reaction zone (in the first catalyst bed), in relative terms, is at least 20 °C, more preferably at least 40 °C, even more preferably at least 60 °C, most preferably at least 80 °C and in particular at least 100 °C higher than the temperature in the second reaction zone (in the second catalyst bed).

Preferably, the temperature in the first reaction zone (in the first catalyst bed), in relative terms, is at least 120 °C, more preferably at least 140 °C, even more preferably at least 160 °C, most preferably at least 180 °C and in particular at least 200 °C higher than the temperature in the second reaction zone (in the second catalyst bed).

Preferably, the temperature of the offgas on entry into the first reaction zone (into the first catalyst bed) is at least 400 °C, more preferably at least 425 °C, even more preferably at least 450 °C, most preferably at least 500 °C.

Preferably, the temperature of the offgas on departure from the second reaction zone (from the second catalyst bed) is at most 600 °C, more preferably at most 550 °C, even more preferably at most 500 °C.

In preferred embodiments, the temperature of the offgas on entry into the first reaction zone (into the first catalyst bed), in relative terms, is at least 20 K, more preferably at least 40 K, even more preferably at least 60 K, most preferably at least 80 K and in particular at least 100 K higher than the temperature of the offgas on entry into the second reaction zone (into the second catalyst bed).

In preferred embodiments, the temperature of the offgas on entry into the second reaction zone (into the second catalyst bed), in relative terms, is at least 10 K, more preferably at least 20 K, even more preferably at least 30 K, most preferably at least 40 K and in particular at least 50 K higher than the temperature of the offgas on entry into the first reaction zone (into the first catalyst bed).

In preferred embodiments, the temperature in the first reaction zone (in the first catalyst bed), in relative terms, is at least 120 K, more preferably at least 140 K, even more preferably at least 160 K, most preferably at least 180 K and in particular at least 200 K higher than the temperature in the second reaction zone (in the first catalyst bed).

In preferred embodiments, the temperature in the second reaction zone (in the second catalyst bed), in relative terms, is at least 120 K, more preferably at least 140 K, even more preferably at least 160 K, most preferably at least 180 K and in particular at least 200 K higher than the temperature in the first reaction zone (in the first catalyst bed).

In other preferred embodiments, the first reaction zone and the second reaction zone are spatially connected to one another. In this case, the catalyst bed is preferably a shared catalyst bed, wherein outside influences result in a division into reaction zones, in particular by the site of injection of reducing agent, such that reducing agent is not present uniformly across the catalyst bed.

Preferably, the first reaction zone and the second reaction zone are disposed in a shared vessel.

Preferably, the offgas temperature in the first reaction zone and in the second reaction zone is in each case independently at most 500 °C, preferably in each case independently in the range from 350 to 450 °C.

In preferred embodiments, the space velocity in the first reaction zone is greater than the space velocity in the second reaction zone. Preferably, the space velocity in the first reaction zone is greater at least by a factor of 1.2, more preferably at least a factor of 1.4, even more preferably at least a factor of 1.6, most preferably at least a factor of 1.8 and in particular at least a factor of 2.0 than the space velocity in the second reaction zone.

In other preferred embodiments, the space velocity in the second reaction zone is greater than the space velocity in the first reaction zone. Preferably, the space velocity in the second reaction zone is greater at least by a factor of 1.5, more preferably at least a factor of 2.0, even more preferably at least a factor of 3.0, most preferably at least a factor of 5.0 and in particular at least a factor of 10.0 than the space velocity in the first reaction zone.

In the context of the invention, “space velocity” means the quotient of the volume flow rate of the gas mixture conducted through the catalyst bed (measured at 0 °C and 1.014 bara and typically re-ported in standard m³·h⁻¹), based on the volume of the catalyst or catalyst bed. The space velocity can thus be adjusted via the volume flow rate of the gas and/or the amount of catalyst.

Preferably, the offgas on entry into the offgas treatment system is at a temperature of at least 300 °C, more preferably at least 350 °C, even more preferably at least 400 °C, most preferably at least 425 °C, and in particular at least 450 °C.

Preferably, the offgas on entry into the offgas treatment system is at a temperature of at least 500 °C, more preferably at least 550 °C, even more preferably at least 600 °C, most preferably at least 625°C, and in particular at least 650 °C.

Preferably, the offgas on entry into the offgas treatment system is at a temperature of at most 825 °C, more preferably at most 800 °C, even more preferably at most 775 °C, most preferably at most 750 °C, and in particular at most 725 °C.

Preferably, the offgas on entry into the offgas treatment system is at a temperature of at most 700 °C, more preferably at most 650 °C, even more preferably at most 600 °C, most preferably at most 550°C, and in particular at most 500 °C.

Preferably, the offgas on entry into the offgas treatment system is at a temperature which, in relative terms, is at least 20 °C, preferably at least 40 °C, more preferably at least 60 °C, even more preferably at least 80 °C, most preferably at least 100 °C, and in particular at least 120 °C, below the temperature of the offgas on departure from the firing system, preferably the internal combustion engine, the gas turbine or the furnace.

Preferably, the offgas on entry into the offgas treatment system is at a pressure of at most 1.4 bara, preferably of at most 1.3 bara, more preferably of at most 1.2 bara.

Preferably, the offgas on entry into the offgas treatment system has a degree of oxidation of NOₓ of at least 10%, more preferably at least 20%, even more preferably at least 30%, most preferably at least 40%, and in particular at least 50%.

Preferably, the offgas on entry into the offgas treatment system has a degree of oxidation of NOₓ of at most 90%, more preferably at most 80%, even more preferably at most 70%, most preferably at most 60%, and in particular at most 50%.

Depending on the combustion temperature, the degree of oxidation may also be significantly lower, and the degree of oxidation decreases with increasing combustion temperature. Preferably, the offgas on entry into the offgas treatment system has a degree of oxidation of NOₓ of at most 15%, more preferably at most 12.5%, even more preferably at most 10%, most preferably at most 7.5%, and in particular at most 5.0%.

Preferably, the offgas on entry into the offgas treatment system has an O₂ content of less than 2.0% by volume.

Preferably, the offgas on entry into the offgas treatment system has an O₂ content of more than 4.0% by volume.

In step (c) of the method of the invention, the N₂O content in the offgas is reduced. This can be effected in various ways, namely by (c₁) decomposition of N₂O over an N₂O decomposition catalyst and/or by (c₂) chemical reduction of N₂O with reducing agent over an N₂O reduction catalyst. Step (c) of the method of the invention is performed in the offgas treatment system.

In preferred embodiments, step (c) comprises reducing the N₂O content in the offgas by (c₁) decomposition of N₂O over an N₂O decomposition catalyst.

In preferred embodiments, the N₂O decomposition catalyst comprises a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL structure type.

In other preferred embodiments, the N₂O decomposition catalyst is an NOₓ-sensitive N₂O decomposition catalyst within the context of the invention, which has already been described in detail above. In this case, the offgas preferably first passes through step (d), i.e. the NOₓ content in the offgas is first reduced by chemical reduction of NOₓ with reducing agent over an NOₓ reduction catalyst, preferably quantitatively, before the offgas then comes into contact with the NOₓ-sensitive N₂ decomposition catalyst.

Preferably, the N₂O decomposition catalyst is disposed in a radial basket through which the flow passes axially.

The N₂O decomposition catalyst is preferably particulate and comprises at least 50 particles.

In preferred embodiments, step (c) comprises reducing the N₂O content in the offgas by (c₂) chemical reduction of N₂O with reducing agent over an N₂O reduction catalyst; preferably wherein the N₂O reduction catalyst comprises a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL structure type.

Preferably, the N₂O reduction catalyst is disposed in a radial basket through which the flow passes axially.

The N₂O reduction catalyst is preferably particulate and comprises at least 50 particles.

In preferred embodiments, step (c) comprises reducing the N₂O content in the offgas
both by (c₁) decomposing N₂O over an N₂O decomposition catalyst; preferably wherein the N₂O decomposition catalyst is a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL structure type;
thus also by (c₂) chemical reduction of N₂O with reducing agent over an N₂O reduction catalyst; preferably wherein the N₂O reduction catalyst comprises a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL structure type.

Preferably, the reducing agent in step (c₂) is selected from NH₃, hydrocarbons, CO, H₂ and mixtures thereof; preferably NH₃.

In preferred embodiments, the reducing agent in step (c₂) is NH₃, which is preferably used in an amount of 0.5 to 2.0 molar parts, preferably in an amount of 0.8 to 1.8 molar parts, based on a molar proportion of N₂O to be reduced chemically, i.e. based on the amount of N₂O at the inlet into the catalyst bed of the N₂O reduction catalyst.

In preferred embodiments, the reducing agent in step (c₂) is NH₃, which is preferably used in an amount of 0.5 to 2.0 molar parts, more preferably in an amount of 0.8 to 1.8 molar parts based on the molar amount of N₂O in the offgas at the inlet into the catalyst bed of the N₂O reduction catalyst. This amount is additive to any required amount of NH₃ for NOₓ reduction if step (d) likewise proceeds in the catalyst bed of the N₂O reduction catalyst.

In other preferred embodiments, the reducing agent is a hydrocarbon or a mixture of two or more hydrocarbons, which are preferably used in an amount of 0.2 to 1.0 molar part, more preferably of 0.2 to 0.7 molar part, based on the molar amount of N₂O in the offgas at the inlet into the catalyst bed of the N₂O reduction catalyst. This amount is likewise additive to any required amount of NH₃ for NOₓ reduction if step (d) likewise proceeds in the catalyst bed of the N₂O reduction catalyst, or the apparatus of the invention is configured correspondingly.

The reducing agent may likewise already be present in the offgas, for example in the form of residual fuels and/or oxidation products thereof. In that case, the method of the invention not only reduces the content of nitrogen oxides (NOₓ and N₂O) but also the content of these impurities (residual fuels and/or oxidation products thereof).

In step (d) of the method of the invention, the content of NOₓ (i.e. NO and NO₂) in the offgas is reduced. This is effected by chemical reduction of NOₓ with reducing agent over an NOₓ reduction catalyst. Step (d) of the method of the invention is likewise conducted in the offgas treatment system.

The NOₓ reduction catalyst preferably contains a zeolitic material; preferably a zeolite laden with transition metal (including lanthanide), in particular with iron, cobalt or copper; more preferably an iron-laden zeolite comprises; even more preferably an iron-laden zeolite of the MFI, BEA, FER, MOR, FAU and/or MEL structure type.

Preferably, the NOₓ reduction catalyst is disposed in a radial basket through which the flow passes axially.

Preferably, the NOₓ reduction catalyst is particulate and comprises at least 50 particles.

Preferably, the reducing agent in step (d) is selected from NH₃, hydrocarbons, CO, H₂ and mixtures thereof; preferably NH₃.

Preferably, the reducing agent in step (d) is NH₃, which is used in an amount of 0.9 to 2.5 molar parts, preferably 1.0 to 1.4 molar parts, preferably 1.0 to 1.2 molar parts, based on a molar proportion of NOₓ to be chemically reduced.

In preferred embodiments, the reducing agent in step (c₂) is the same as the reducing agent in step (d); preferably NH₃.

In addition to NH₃, in steps (c₂) and/or (d) of the method of the invention, other nitrogen-containing reducing agents are also suitable in principle, for example hydrogen compounds of nitrogen, such as azanes, hydroxyl derivatives of azanes, and amines, oximes, carbamates, urea or urea derivatives. Examples of azanes are hydrazine and very particularly ammonia. Examples of hydroxyl derivatives of azanes are hydroxylamine. Examples of amines are primary aliphatic amines, such as methylamine. One example of carbamates is ammonium carbamate. Examples of urea derivatives are N,N′-substituted ureas, such as N,N′-dimethyl urea. Urea and urea derivatives are preferably used in the form of aqueous solutions. Particular preference is given to ammonia or substances that release ammonia on introduction, such as urea or ammonium carbamate.

Particularly preferred process regimes of the invention are elucidated in detail below:

### DeNOₓ—deN₂O—Variant 1

In preferred embodiments, the offgas treatment system comprises a first reaction zone and a second reaction zone beyond, through which the offgas passes successively;
wherein reducing agent is added to the offgas upstream of the first reaction zone;
wherein, in the first reaction zone, the NOₓ content in the offgas is first reduced by chemical reduction of NOₓ with reducing agent over an NOₓ reduction catalyst (step (d)) (deNOₓ stage); wherein the N₂O content in the offgas is optionally additionally reduced by decomposition of N₂O over an N₂O decomposition catalyst (step (c₁)) and/or by chemical reduction of N₂O with reducing agent over an N₂O reduction catalyst (step (c₂));
wherein further reducing agent is optionally added to the offgas upstream of the second reaction zone; and
wherein, in the second reaction zone, the N₂O content in the offgas is then reduced by decomposition of N₂O over an N₂O decomposition catalyst (step (c₁)) and/or by chemical reduction of N₂O with reducing agent over an N₂O reduction catalyst (step (c₂)) (deN₂O stage); wherein the NOₓ content in the offgas is optionally additionally further reduced by chemical reduction of NOₓ over an NOₓ reduction catalyst (step (d)).

Preferably, the NOₓ reduction catalyst in the first reaction zone comprises a conventional, preferably non-zeolitic SCR catalyst, for example based on V₂O₅-WO₃—/TiO₂.

Preferably, the temperature of the offgas on entry into the first reaction zone is at most 400 °C, preferably at most 350 °C.

Preferably, the N₂O decomposition catalyst in the second reaction zone comprises a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL structure type.

Preferably, the temperature of the offgas on entry into the second reaction zone is in the range from 300 to 550 °C, preferably 350 to 500 °C.

Preferably, the offgas after leaving the first reaction zone and before entering the second reaction zone has an NOₓ content in the range from 0 to 200 ppmv, preferably 1 to 200 ppmv, and an N₂O content in the range from 200 to 2000 ppmv.

### DeNOₓ—deN₂O—Variant 2

In other preferred embodiments, the offgas treatment system likewise comprises a first reaction zone and a second reaction zone beyond, through which the offgas passes successively;
wherein reducing agent is added to the offgas upstream of the first reaction zone;
wherein, in the first reaction zone, the NOₓ content in the offgas is first reduced by chemical reduction of NOₓ with reducing agent over an NOₓ reduction catalyst (step (d)) (deNOₓ stage); wherein the N₂O content in the offgas is optionally additionally reduced by decomposition of N₂O over an N₂O decomposition catalyst (step (c₁)) and/or by chemical reduction of N₂O with reducing agent over an N₂O reduction catalyst (step (c₂));
wherein further reducing agent is optionally added to the offgas upstream of the second reaction zone; and
wherein, in the second reaction zone, the N₂O content in the offgas is then reduced by decomposition of N₂O over an N₂O decomposition catalyst (step (c₁)) and/or by chemical reduction of N₂O with reducing agent over an N₂O reduction catalyst (step (c₂)) (deN₂O stage); wherein the NOₓ content in the offgas is optionally additionally further reduced by chemical reduction of NOₓ over an NOₓ reduction catalyst (step (d)).

Preferably, the NOₓ reduction catalyst in the first reaction zone comprises a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL structure type.

Preferably, the offgas temperature on entry into the first reaction zone is at least 300°C, more preferably at least 350 °C, even more preferably at least 400 °C. Preferably, the temperature of the offgas on entry into the first reaction zone is at most 600 °C, more preferably at most 550 °C.

Preferably, the N₂O decomposition catalyst in the second reaction zone comprises an NOₓ-sensitive N₂O decomposition catalyst within the context of the invention, which has already been described in detail above.

Preferably, the offgas temperature on entry into the second reaction zone is at least 300 °C, more preferably at least 350 °C, even more preferably at least 400 °C. Preferably, the temperature of the offgas on entry into the second reaction zone is at most 600 °C, more preferably at most 550 °C.

Preferably, the offgas after leaving the first reaction zone and before entering the second reaction zone has an NOₓ content of at most 20 ppmv, more preferably at most 10 ppmv, even more preferably at most 5 ppmv, and an N₂O content in the range from 200 to 2000 ppmv.

### Particularly Preferred Embodiments of DeNOₓ—deN₂O—Variant 2

In particularly preferred embodiments, the offgas treatment system of the invention comprises a first catalyst bed and a spatially separated second catalyst bed; wherein the first catalyst bed is disposed upstream of the second catalyst bed in flow direction of the offgas; wherein a first apparatus with a first control valve for metered addition of NH₃ to the offgas is optionally and preferably disposed upstream of the first catalyst bed; wherein a second apparatus with a second control valve for metered addition of NH₃ to the offgas is disposed downstream of the first catalyst bed and upstream of the second catalyst bed, with which further NH₃ is metered into the offgas; wherein both the first catalyst bed and the second catalyst bed each contain an iron-laden zeolite catalyst; wherein (i) in the first catalyst bed (c₁), N₂O is decomposed; and (d) NOₓ is incompletely chemically reduced with NH₃, where at least a portion of the NH₃ optionally and preferably comes from incomplete combustion of NH₃ in step (a) (NH₃ slip); and (ii) in the second catalyst bed (c₂), residual N₂O is chemically reduced with NH₃ and (c1*) residual N₂O is optionally decomposed; and (d*) residual NOₓ is chemically reduced with NH₃.

Preferably, the catalytic decomposition of N₂O in the first catalyst bed is cocatalyzed by NOₓ present in the offgas.

Preferably, the incomplete chemical reduction of NOₓ with NH₃ in the first catalyst bed leads down to a predetermined residual NOₓ content which is sufficient to bring about a cocatalytic effect on the decomposition of N₂O in the first catalyst bed. Since the chemical reduction of NOₓ with NH₃ in the first catalyst bed typically proceeds much more quickly than the chemical reduction of N₂O with NH₃, and the amount of NOₓ chemically reduced in the first catalyst bed is not the whole amount, the extent of any parallel chemical reduction of N₂O with NH₃ in the first catalyst bed is typically negligible.

Preferably, additional NH₃ for NOₓ reduction is metered into the offgas by means of the first apparatus; preferably under feedback control, i.e. a particular value for the concentration of NOₓ on departure from the first catalyst bed is defined as the target value (setpoint) and the actual concentration of NOₓ on departure from the first catalyst bed is measured (actual value); and in the event of a difference between setpoint and actual value (control difference), the output of the first control valve is altered in order to minimize the difference. Preferably, the setpoint of the NOₓ concentration on departure from the first catalyst bed and hence the amount of additional NH₃ is chosen such that the residual concentration of NOₓ on departure from the first catalyst bed is at most 1000 ppmv, preferably at most 500 ppmv, more preferably at most 100 ppmv. Preferably, the setpoint of the NOₓ concentration on departure from the first catalyst bed and hence the amount of additional NH₃ is chosen such that the residual concentration of NOₓ on departure from the first catalyst bed is at least 10 ppmv, preferably at least 20 ppmv, more preferably at least 40 ppmv. The expected specific consumption of NH 3 for the chemical reduction of NOₓ in the first catalyst bed is typically in the range from 0.9 to 1.1 mol of NH₃ per mole of reduced NOₓ and is therefore significantly smaller than the expected specific (mol/mol) consumption of NH₃ in the second catalyst bed.

Preferably, the temperature of the offgas on departure from the first catalyst bed is in the range from 400 to 550 °C.

Preferably, the offgas on departure from the first catalyst bed is at a pressure greater than atmospheric pressure, i.e. ≥1.0 bara, but at most 1.2 bara, more preferably at most 1.1 bara.

Preferably, the offgas on departure from the first catalyst bed has a degree of oxidation of NOₓ of at least 5.0%, preferably at least 7.5%, more preferably at least 10%, even more preferably at least 12.5%, most preferably at least 15%, and in particular at least 17.5%.

In preferred embodiments, the offgas on departure from the first catalyst bed has a degree of oxidation of NOₓ in the range from 30% to 50%.

In other preferred embodiments, the offgas on departure from the first catalyst bed has a degree of oxidation of NOₓ in the range from 15% to 35%, preferably 15% to 30%.

In further preferred embodiments, the offgas on departure from the first catalyst bed has a degree of oxidation of NOₓ in the range from 10% to 20%.

In other preferred embodiments, the offgas on departure from the first catalyst bed has a degree of oxidation of NOₓ in the range from 5% to 15%.

Preferably, residual N₂O is broken down in the second catalyst bed down to a residual concentration of N₂O on departure from the second catalyst bed of at most 20 ppmv, more preferably at most 10 ppmv, even more preferably at most 5 ppmv, most preferably at most 2 ppmv.

Preferably, residual NOₓ is broken down in the second catalyst bed down to a residual concentration of NOₓ on departure from the second catalyst bed of at most 20 ppmv, more preferably at most 10 ppmv, even more preferably at most 5 ppmv, most preferably at most 2 ppmv.

Preferably, the further NH₃ is metered in with the second apparatus under feed-forward control, i.e. the concentrations of NOₓ and optionally preferably of N₂O are measured in each case on departure from the first catalyst bed or optionally in each case on entry into the second catalyst bed; the amount of offgas entering the second catalyst bed is taken into account to calculate the amount of NH₃ required for NOₓ reduction and optionally preferably the sum total of that required for NOₓ reduction and for N₂O reduction with the aid of stored ratios, i.e., for example, molar ratios (mol/mol) of NH₃/NOₓ and optionally preferably of NH₃/N₂O or factors derived therefrom; and the calculated result (manipulated variable) is used to alter the output of the second control valve in order to meter in the required amount of NH₃.

Preferably in accordance with the invention, the molar NH₃ concentration [NH₃] of the offgas on entry into the second catalyst bed is in the range from the sum of 0.7×[N₂O] and 1.0×[NOₓ] to the sum of 4.0×[N₂O] and 2.0×[NOₓ], more preferably in the range from the sum of 1.0×[N₂O] and 1.1×[NOₓ] to the sum of 3.0×[N₂O] and 1.6×[NOₓ], even more preferably in the range from the sum of 1.5×[N₂O] and 1.2×[NOₓ] to the sum of 2.5×[N₂O] and 1.4×[NOₓ], where [N₂O] is the molar concentration of N₂O and [NOₓ] is the molar concentration of NOₓ, each in the offgas on entry into the second catalyst bed.

Preferably, for the feed-forward control of the metered addition of NH₃ into the second catalyst bed with regard to the NOₓ reduction, a molar ratio of NH₃/NOₓ in the range from 1.0 to 2.0; preferably 1.1 to 1.6; more preferably 1.2 to 1.4 is chosen.

Preferably, for the feed-forward control of the metered addition of NH₃ into the second catalyst bed with regard to the N₂O reduction, a molar ratio of NH₃/N₂O in the range from 0.7 to 4.0; preferably 1.0 to 3.0; more preferably 1.5 to 2.5 is chosen.

Preferably, the further NH₃ is not metered in with the second apparatus under feedback control, since the aim is maximum chemical reduction of NOₓ in the second catalyst bed, meaning that the result is zero or only very small residual concentrations of NOₓ and N₂O, which would be of limited utility as control variables.

Preferably, the amount of catalyst, i.e. the space velocity (=ratio of offgas volume flow rate under standard conditions to catalyst volume) is chosen in such a way that breakdown of N₂O is at least 50% in the first catalyst bed, preferably at least 70%, more preferably at least 80%, based on the concentration of N₂O on entry into the first catalyst bed.

Preferably, the catalyst amount and the amount of additional NH₃ are chosen such that, on departure from the first catalyst bed, the molar ratio of NOₓ/N₂O is at least 5, more preferably at least 10, even more preferably at least 20.

The space velocity of the first catalyst bed is preferably in the range from 5000 h⁻¹ to 100 000 h⁻¹, more preferably 10 000 h⁻¹ to 50 000 h⁻¹, even more preferably 15 000 h⁻¹ to 45 000 h⁻¹.

If the molar ratio of NOₓ/N₂O on departure from the first catalyst bed is at least 10, the metered addition of NH₃ via the second apparatus can then preferably be effected solely in relation to the amount of incoming NOₓ.

Preferably, the offgas temperature on entry into the first catalyst bed is at least 400 °C, more preferably at least 425 °C, even more preferably at least 450°C. Preferably, the offgas temperature on entry into the first catalyst bed is not more than 550 °C, more preferably not more than 525 °C, even more preferably not more than 500 °C. The temperature can be adjusted by measures known to those skilled in the art, in particular design of heat exchangers and conditions for the combustion of NH₃.

Depending on the exothermicity of the chemical reactions that proceed in the first catalyst bed and in the second catalyst bed, the inlet temperature of the offgas into the first catalyst bed is preferably chosen such that the temperature of the offgas on departure from the second catalyst bed is at most 600°C, more preferably at most 550 °C, even more preferably at most 520 °C.

The space velocity of the second catalyst bed is preferably in the range from 5000 h⁻¹ to 100 000 h⁻¹, more preferably 10 000 h⁻¹ to 50 000 h⁻¹ , even more preferably 15 000 h⁻¹ to 45 000 h⁻¹.

Preferably, the ratio of catalyst volumes (V1_{cat}/V2_{cat}) of the first catalyst bed V1_{cat} to the second catalyst bed V2_{cat} is in the range from ½ to 20/1, preferably ½ to 10/1, more preferably 1/1 to 4/1.

In preferred embodiments, at least one, more than one or all of the following conditions are met:
the pressure of the offgas on entry into the first catalyst bed is at most 5 bara, preferably at most 4 bara, more preferably at most 1.3 bara, most preferably at most 1.2 bara and in particular at most 1.1 bara;
the H₂O content in the offgas on entry into the first catalyst bed is at least 5% by volume, more preferably at least 10% by volume, even more preferably at least 15% by volume, most preferably at least 20% by volume and in particular at least 25% by volume;
the NOₓ content in the offgas on entry into the first catalyst bed is at least 500 ppmv, more preferably at least 1000 ppmv, even more preferably at least 1500 ppmv, most preferably at least 2000 ppmv, and in particular at least 2500 ppmv;
the N₂O content in the offgas on entry into the first catalyst bed is at most <500 ppmv, more preferably at most 200 ppmv, even more preferably at most 100 ppmv, but at least 5 ppmv, preferably at least 10 ppmv, more preferably at least 50 ppmv;
the offgas on entry into the first catalyst bed contains uncombusted residues of NH₃ from the combustion of NH₃;
the N₂O decomposition catalyst and/or the N₂O reduction catalyst takes the form of a honeycomb body;
the NOₓ reduction catalyst takes the form of a honeycomb body;
the first catalyst bed contains Fe zeolite;
the second catalyst bed contains Fe zeolite;
the offgas passes through a heat exchanger before entering the first catalyst bed and is heated therein;
the NOₓ content on departure from the first catalyst bed is at most 1000 ppmv, more preferably at most 500 ppmv, even more preferably at most 300 ppmv, most preferably at most 100 ppmv; but preferably at least 10 ppmv, more preferably at least 20 ppm, even more preferably at least 40 ppmv, most preferably at least 100 ppmv, and in particular at least 250 ppmv;
the N₂O content on departure from the first catalyst bed is at most 20 ppmv, more preferably at most 15 ppmv, even more preferably at most 10 ppmv, most preferably at most 5 ppmv and in particular at most 2 ppmv;
there is no intermediate cooling of the offgas after departure from the first catalyst bed up to entry into the second catalyst bed;
the molar ratio of N₂O:NOₓ on entry into the first catalyst bed is at most 0.5, more preferably at most 0.2, even more preferably at most 0.1;
the molar ratio of N₂O:NOₓ on departure from the first catalyst bed is at most 0.20, more preferably at most 0.1, even more preferably at most 0.05;
the feeding of NH₃ into the offgas upstream of the first catalyst bed in flow direction of the offgas is optional; if there is feeding, it is preferably substoichiometric with respect to the NOₓ content on entry into the first catalyst bed;
the feeding of NH₃ into the offgas downstream of the first catalyst bed and upstream of the second catalyst bed in flow direction of the offgas is obligatory and preferably superstoichiometric with respect to the total content of NOₓ and N₂O on entry into the second catalyst bed.

The above-described method using Fe zeolite catalysts in two catalyst beds, by comparison with conventional deNOₓ methods using V₂O₅/TiO₂ catalysts, enables
complete or almost complete breakdown of large amounts of NOₓ without the risk of NH₃ slip; and
simultaneous, complete or virtually complete breakdown of N₂O
at comparatively low catalyst volumes, i.e. at comparatively high space velocities.

Aside from the operating method of the invention, this is achieved by the oxidative properties of the Fe zeolite catalysts used in accordance with the invention. Thus, in the first catalyst bed, the molar ratio of NO to NO₂, according to the invention, is brought as close as possible to the thermodynamic equilibrium position. For instance, the degree of oxidation of NOₓ (molar ratio of NO₂/(NO+NO₂)) prior to entry into the first catalyst bed, because of the upstream NH₃ combustion at very high temperatures and the only slow establishment of the equilibrium in the gas phase when the offgas is cooled in any downstream heat exchanger(s), is less than 5% as expected, and hence well below the thermodynamic equilibrium applicable to the inlet temperature into the first catalyst bed. However, this is very disadvantageous for an efficient chemical reduction of NOₓ since, as a result, only a small portion of the NOₓ present in the offgas can be broken down by a fast SCR and a majority of the NOₓ or of the remaining NO has to be broken down by significantly slower normal SCR.

The chosen mode of operation of the limited metered addition of NH₃ in the first catalyst bed and the ability of the Fe zeolite catalysts to oxidize NO or to catalytically accelerate the establishment of equilibrium results in achievement of a distinctly faster, i.e. more efficient, chemical reduction of NOₓ, and at the same time establishment of the maximum possible degree of oxidation of NOₓ in the exiting residual NOₓ. This enables efficient chemical reduction of NOₓ in the second catalyst bed too from the very start.

It has thus been found that large amounts of NH₃, as needed for complete chemical reduction of high concentrations of NOₓ, similarly to water, inhibit the establishment of the NOₓ equilibrium on the Fe zeolite catalyst.

In addition, the chemical reduction of NOₓ as such is likewise inhibited by NH₃ itself in the case of a correspondingly high dosage of NH₃. As a result, depending on temperature, amount of catalyst and NOₓ content, no further increase in NOₓ breakdown occurs with rising addition of NH₃ over and above a particular amount of NH₃. In the case of a further increase in the addition of NH₃, it is then even possible under some circumstances that a decline in NOₓ breakdown will be observed with a simultaneous NH₃ slip.

Chemical reduction of the NOₓ previously in the first catalyst bed distinctly reduces the amount of NH₃ needed for chemical reduction of NOₓ in the second catalyst bed.

In this way, together with the above-described establishment or permanent readjustment of the NOₓ equilibrium, a very efficient chemical reduction of NOₓ is also possible in the second catalyst bed, even with the superstoichiometric metered addition of NH₃ in accordance with the invention.

The fact that this is additionally effected in accordance with the invention with a zero or only insignificant NH₃ slip of preferably at most 10 ppmv, more preferably at most 5 ppmv, even more preferably at most 3 ppmv is likewise because of the oxidative properties of the Fe zeolite catalysts used in accordance with the invention. If the inlet temperature of the offgas into the second catalyst bed is preferably at least 400 °C, more preferably at least 425 °C, even more preferably at least 450 °C, the NH₃ metered in in excess within the limits of the invention is selectively oxidized by the residual oxygen content of the offgas present to N₂ and H₂O.

All these advantages cannot be achieved in a single or multistage arrangement when using conventional V₂O₅/TiO₂-based SCR catalysts as typically also used for denoxing of offgases from natural gas-fired reformers. Thus, for reasons of stability, these conventional SCR catalysts typically cannot be operated at temperatures above 400 °C, which limits the achievable speeds of the breakdown reaction. It is also the case that conventional SCR catalysts have only very limited oxidation activity, and so establishment or permanent readjustment of the NOₓ equilibrium is not possible, nor do these catalysts enable effective and N₂-selective oxidation of NH₃ metered in in excess. Instead, there is then even a risk of unwanted formation of N₂O.

In a variant of the above-described embodiments which is preferred in accordance with the invention, the first catalyst bed and the second catalyst bed contain the same catalyst. In preferred embodiments, the second apparatus with a second control valve for metered addition of NH₃ to the offgas is omitted, while the spatial separation of the first catalyst bed from the second catalyst bed is preferably omitted-in that case, there is in fact only a single shared catalyst bed, with a first apparatus having a first control valve for metered addition of NH₃ to the offgas preferably disposed upstream of this shared catalyst bed. Additional NH₃ is preferably metered into the offgas via the first apparatus; preferably under feed-forward control, i.e. the concentration of NOₓ, N₂O and NH₃ in the offgas upstream of the shared catalyst bed is measured; the amount of offgas entering the shared catalyst bed is taken into account to calculate the additional amount of NH₃ still required; and the calculated result (manipulated variable) is used to alter the output of the first control valve in order to meter in the amount of additional NH₃ still required. Preferably, in such embodiments, an NH₃ oxidation catalyst is disposed downstream of the shared catalyst bed in order to reduce possible NH₃ slip.

### Simultaneous Firing of NH₃ and CH₄—Reduction of the Hydrogen Cyanide Content

In preferred embodiments, in step (a), a mixture of CH₄ and NH₃ with air and/or oxygen is combusted to produce an offgas additionally containing CO₂, CO and HCN as well as NOₓ and N₂O.

In these cases, the first catalyst bed preferably assumes the additional function of catalytic cracking of HCN by hydrolysis with water present in the offgas to give the CO and NH₃ products as follows: HCN+H₂O↔CO+NH₃. The CO and NH₃ products formed can then, with regard to NH₃, preferably be utilized for NOₓ reduction in the first catalyst bed, and, with regard to CO, preferably for N₂O reduction in the second catalyst bed as reducing agent for the elimination of N₂O and NOₓ in the offgas.

The content of HCN in the offgas, as a pollutant and greenhouse gas, has to be limited or eliminated owing to its toxicity and longevity in the atmosphere and its absorption in the infrared. The fact that when HCN is broken down in accordance with the invention over zeolite catalysts in the first catalyst bed with CO and NH₃, cracking products are formed that are suitable as reducing agents for the further offgas aftertreatment of NOₓ and N₂O in the second catalyst bed completes the singularity of the inventive offgas treatment over zeolite catalysts. Conventional SCR catalysts based on vanadium oxide show virtually no activity for HCN hydrolysis and are therefore unsuitable for elimination of HCN from offgases. In this case, a downstream oxidation catalyst would have to be used.

### Waste Heat Steam Generator

In preferred embodiments, the offgas treatment system of the invention comprises a first waste heat steam generator and preferably a second waste heat steam generator, wherein the first waste heat steam generator is disposed upstream of the second waste heat steam generator in flow direction of the offgas.

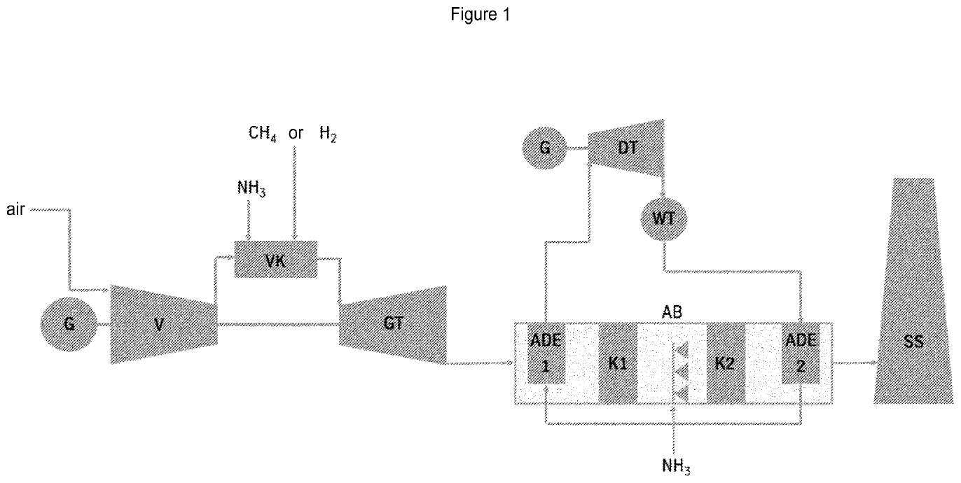

FIGS. 1 to 3 illustrate, in schematic form, embodiments that are preferred in accordance with the invention by which a first waste heat steam generator (ADE1), a second waste heat steam generator (ADE2), a first catalyst bed (K1) and a second catalyst bed (K2) can be positioned and contacted with the hot turbine offgas downstream of the turbine outlet. A generator (G) drives a compressor (V) in which air is compressed. Ammonia is combusted in a combustion chamber (VK, combustion chamber), possibly in a mixture with CH₄ or H₂, and the offgas formed flows into a gas turbine (GT) under expansion. After exiting from the gas turbine (GT), the offgas is fed into an offgas treatment system (AB) comprising the first waste heat steam generator (ADE1), the second waste heat steam generator (ADE2), the first catalyst bed (K1) and the second catalyst bed (K2). In the second waste heat steam generator (ADE2) and then also in the first waste heat steam generator (ADE1), water vapor absorbs heat from the offgas. The heated water vapor is fed to a steam turbine driven by a generator (G) and then flows through a heat exchanger (WT). After leaving the offgas treatment system (AB), the offgas is fed to a chimney (SS).

In preferred embodiments, the offgas flows first through the first waste heat steam generator, then the first catalyst bed, then the second catalyst bed and finally the second waste heat steam generator (FIG. 1).

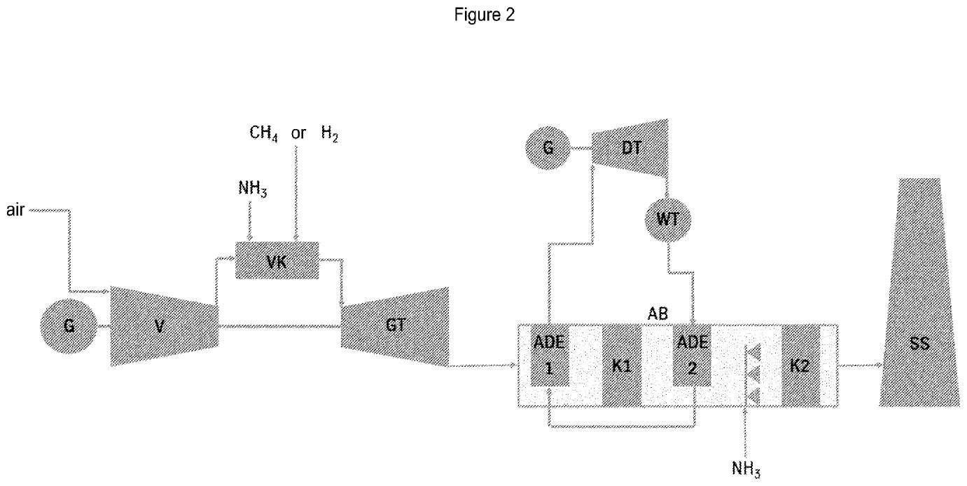

In other preferred embodiments, the offgas flows first through the first waste heat steam generator, then the first catalyst bed, then the second waste heat steam generator and finally the second catalyst bed (FIG. 2).

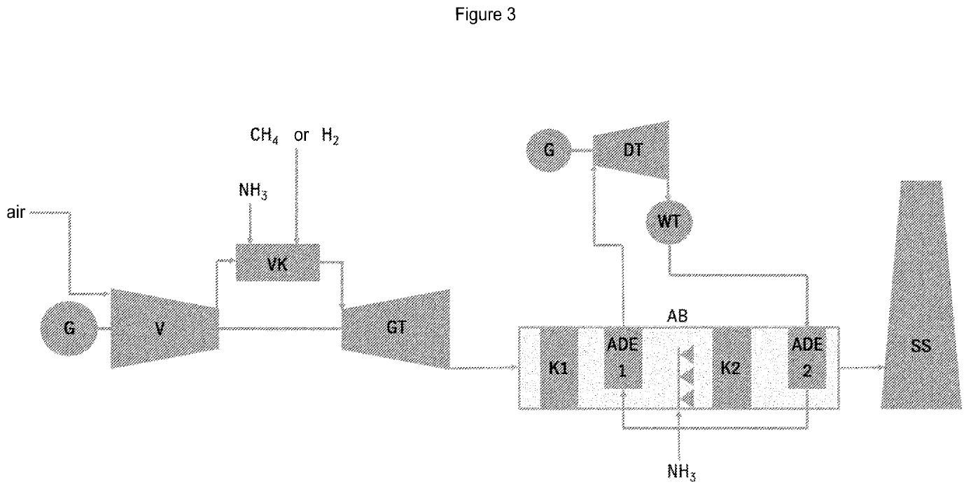

In further preferred embodiments, the offgas flows first through the first catalyst bed, then the first waste heat steam generator, then the second catalyst bed and finally the second waste heat steam generator (FIG. 3).

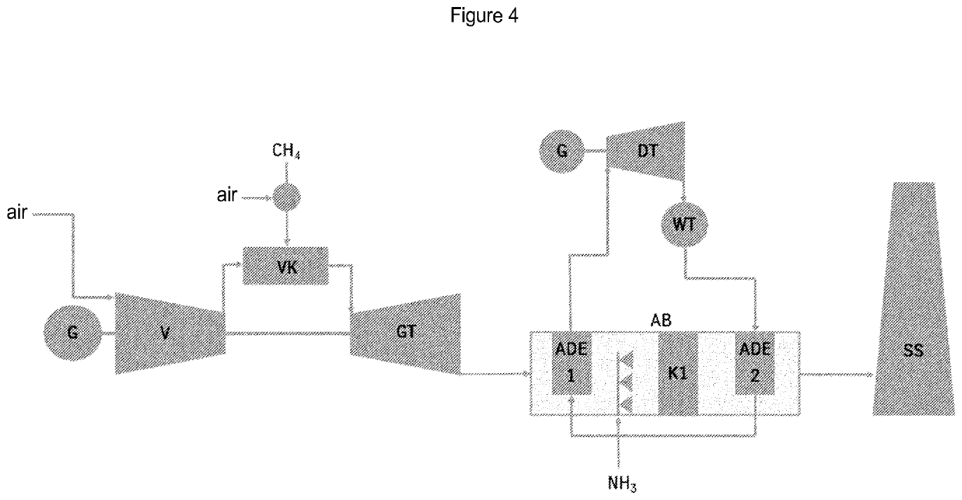

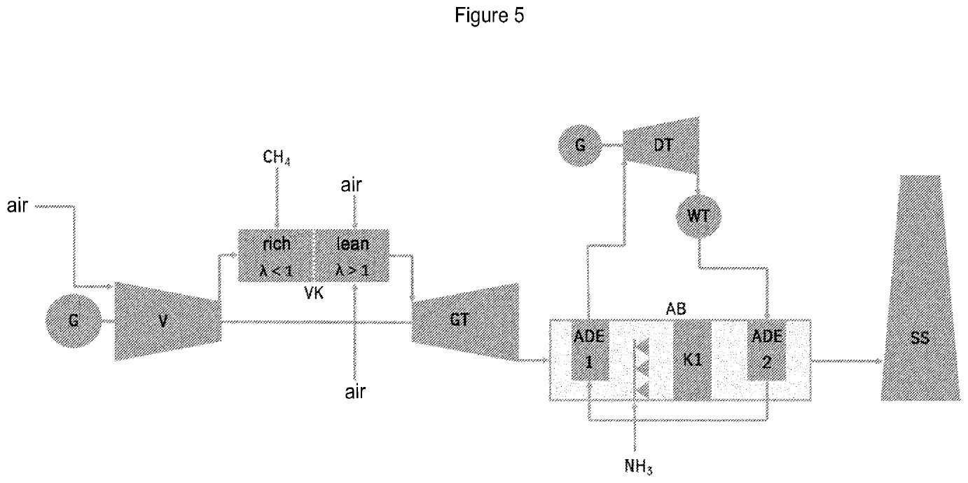

In other embodiments that are less preferred, there is only one catalyst bed, and the combustion is effected in two stages as premix combustion (FIG. 4) or as rich-lean combustion (FIG. 5).

### DeN₂O—deNOₓ

In further preferred embodiments, the offgas treatment system comprises a first reaction zone and a second reaction zone beyond, through which the offgas passes successively;
wherein reducing agent is added to the offgas between the first reaction zone and the second reaction zone;
wherein, in the first reaction zone, the N₂O content in the offgas is first reduced by decomposition of N₂O over an N₂O decomposition catalyst (step (c₁)) (deN₂O stage); and
wherein, in the second reaction zone, the NOₓ content in the offgas is then reduced by chemical reduction of NOₓ with reducing agent over an NOₓ reduction catalyst (step (d)) (deNOₓ stage); wherein the N₂O content in the offgas is optionally additionally further reduced by further decomposition of N₂O over an N₂O decomposition catalyst (step (c₁)) and/or by chemical reduction of N₂O with reducing agent over an N₂O reduction catalyst (step (c₂)).

Preferably, no reducing agent is added to the offgas upstream of the first reaction zone.

Such a process regime is particularly preferred in accordance with the invention. It makes it possible first to adjust the relative content of NOₓ and N₂O without consumption of reducing agents. While the absolute NOₓ content in the first reaction zone remains virtually unchanged, the N₂O content in the offgas is selectively reduced by decomposition. This can be effected to an extent as required to establish the desired relative content of NOₓ and N₂O. For economic reasons, the chosen amount of the N₂O decomposition catalyst is preferably not so great as to achieve quantitatively complete reduction of the N₂O content in the offgas by decomposition (0 ppmv); instead, a compromise is found between breakdown rate and dimensions of the N₂O decomposition catalyst.

In preferred embodiments, the N₂O decomposition catalyst in the first reaction zone comprises a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL structure type.

In other preferred embodiments, the N₂O decomposition catalyst in the first reaction zone comprises an NOₓ-sensitive N₂O decomposition catalyst within the context of the invention, which has already been described above.

In preferred embodiments, the NOₓ reduction catalyst in the second reaction zone comprises a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL structure type.

Preferably, the first reaction zone and the second reaction zone are operated here at different temperature levels.

### Preferably,

the N₂O decomposition catalyst in the first reaction zone comprises an NOₓ-sensitive N₂O decomposition catalyst; wherein the offgas temperature in the first reaction zone is preferably at least 450 °C, more preferably at least 500 °C, even more preferably at least 550 °C, most preferably at least 600 °C; and
the NOₓ reduction catalyst in the second reaction zone is a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL structure type; where the offgas temperature in the second reaction zone is preferably at most 550 °C, more preferably at most 500 °C, even more preferably at most 450 °C, most preferably at most 400 °C; and wherein, in addition to the chemical reduction of NOₓ, the (residual) N₂O content is preferably further reduced in the second reaction zone by decomposition and/or chemical reduction.

Preferably, in the first reaction zone, the space velocity is set in such a way that the N₂O content in the offgas is reduced in the first reaction zone by at most 95%, preferably by at most 90%, preferably by at most 85%, based on the N₂O content in the offgas on entry into the first reaction zone.

In preferred embodiments, the N₂O content in the offgas after leaving the first reaction zone and before entering the second reaction zone is at least 20 ppmv, more preferably at least 40 ppmv, even more preferably at least 60 ppmv, most preferably at least 80 ppmv and in particular at least 100 ppmv.

In preferred embodiments, the N₂O content in the offgas after leaving the first reaction zone and before entering the second reaction zone is at most 400 ppmv, more preferably at most 300 ppmv, even more preferably at most 200 ppmv, most preferably at most 100 ppmv and in particular at most 50 ppmv.

Preferably, in the second reaction zone, the space velocity is set in such a way that the N₂O content in the offgas is further reduced in the second reaction zone by at least 30%, preferably by at least 40%, more preferably by at least 50%, based on the N₂O content in the offgas on entry into the second reaction zone. Since reducing agents are present in the second reaction zone, further reduction of the N₂O content in the second reaction zone can be achieved both by decomposition over an N₂O decomposition catalyst (step (c₁)) and by chemical reduction with reducing agent over an N₂O reduction catalyst (step (c₂)).

Preferably, in the second reaction zone, the N₂O content in the offgas is further reduced by chemical reduction of N₂O with reducing agent over an N₂O reduction catalyst (step (c₂)).

In addition, the NOₓ content is reduced in the second reaction zone by chemical reduction with reducing agent over an NOₓ reduction catalyst. This reduction typically has fast kinetics and preferably proceeds virtually quantitatively in accordance with the invention.

### Closed-loop Control

Regardless of the respective process regime, the method of the invention is preferably under closed-loop control.

In preferred embodiments, depending on the mode of construction of the firing system, preferably the internal combustion engine, the gas turbine or the furnace, for closed-loop control of the method of the invention, the first measured variable measured is at least one parameter which is characteristic of the current operating state of the firing system, preferably the internal combustion engine, the gas turbine or the furnace. Preferably, this first measured variable or the parameter is selected from the group consisting of combustion temperature, NH₃ consumption, speed of rotation if appropriate, and noise emitted by the firing system, preferably the internal combustion engine, the gas turbine or the furnace.

Depending on the characteristics of the offgas that leaves the firing system, preferably the internal combustion engine, the gas turbine or the furnace, in particular
NOₓ content in the offgas;
degree of oxidation of NOₓ in the offgas;
N₂O content in the offgas;
content of other constituents in the offgas, for example H₂O, O₂, and N₂;
offgas temperature;
offgas pressure; and
offgas volume flow rate;
   the method conditions can be optimized in order to achieve an efficient and economically viable reduction of the content of NOₓ and N₂O in the offgas.

In preferred embodiments, therefore, for control of the method of the invention, at least one parameter characteristic of the current state of the offgas prior to entry into the offgas treatment system is measured at the outlet from the firing system, preferably the internal combustion engine, the gas turbine or the furnace; and/or at the inlet into the offgas treatment system as a second measured variable, either in addition to the first measured variable or instead of the first measured variable. Preferably, this second measured variable or parameter is selected from the group consisting of NOₓ content in the offgas; degree of oxidation of the NOₓ in the offgas; N₂O content in the offgas; content of other components in the offgas, for example H₂O, O₂, and N₂; offgas temperature; offgas pressure; and volume flow rate of the offgas.

In preferred embodiments, therefore, for control of the method of the invention, at least one parameter characteristic of the current state of the offgas on departure from the offgas treatment system is measured on departure from the offgas treatment system as a third measured variable, either in addition to the first measured variable or instead of the first measured variable, and either in addition to the second measured variable or instead of the second measured variable. Preferably, this third measured variable or parameter is selected from the group consisting of NOₓ content in the offgas; degree of oxidation of the NOₓ in the offgas; N₂O content in the offgas; content of other components in the offgas, for example H₂O, O₂, and N₂; offgas temperature; offgas pressure; and volume flow rate of the offgas.

In preferred embodiments, especially when the offgas treatment system comprises a first reaction zone and a second reaction zone through which the offgas passes successively, wherein reducing agent is fed in between the first reaction zone and the second reaction zone, for control of the method of the invention, at least one parameter characteristic of the current state of the offgas after leaving the first reaction zone and before entering the second reaction zone is measured on departure from the first reaction zone and before entry into the second reaction zone as a fourth measured variable, either in addition to the first measured variable or instead of the first measured variable, and either in addition to the second measured variable or instead of the second measured variable, and either in addition to the third measured variable or instead of the third measured variable. Preferably, this fourth measured variable or parameter is selected from the group consisting of NOₓ content in the offgas; degree of oxidation of the NOₓ in the offgas; N₂O content in the offgas; content of other components in the offgas, for example H₂O, O₂, and N₂; offgas temperature; offgas pressure; and volume flow rate of the offgas.

Depending on the first measured variable and/or second measured variable and/or the third measured variable and/or the fourth measured variable, at least one manipulated variable is preferably modified for open-loop or closed-loop control of the method of the invention. Preferably, therefore, the open-loop or closed-loop control of the method is based on the first measured variable and/or on the second measured variable and/or on the third measured variable and/or on the fourth measured variable by means of a controlled change in the manipulated variable (control variable), preferably by a controlled change in the amount of reducing agent metered in.

In terms of preferred manipulated variables, a distinction is necessary between
process conditions that can be changed at short notice only with a relatively high apparatus complexity, if at all, and
process conditions that can be changed at short notice and are therefore of better suitability for control of the method.

Preferably in accordance with the invention,
the dimensions of the offgas treatment apparatus;
the nature, amount and flow direction of the N₂O decomposition catalyst and/or N₂O reduction catalyst;
the nature, amount and flow direction of the NOₓ reduction catalyst;
the type of reducing agent;
the offgas pressure;
the feed-in position of reducing agents; and
the relative arrangement of the first reaction zone and the second reaction zone
   are not manipulated variables, i.e. these parameters remain preferably constant during the performance of the method of the invention.

However, these parameters may be chosen or adjusted in the planning and design of the offgas treatment system such that control of the method of the invention is possible within wide limits. In this way, it also is possible to react to changes at short notice, for instance with regard to the offgas to be treated. An efficient and economically viable reduction of the content of NOₓ and N₂O in the offgas remains assured without unwanted breakthrough of reducing agents (called slippage).

Manipulated variables (control variables) that are preferred in accordance with the invention are:
the amount of reducing agent;
if appropriate the offgas temperature; and
if appropriate the temperature of the catalysts.

Preferably, the offgas leaving the offgas treatment system has a residual NOₓ content of at most 20 ppmv, preferably at most 15 ppmv, more preferably at most 10 ppmv, even more preferably at most 7.5 ppmv, most preferably at most 5.0 ppmv, and in particular at most 2.5 ppmv.

Preferably, the offgas leaving the offgas treatment system has a residual N₂O content of at most 20 ppmv, preferably at most 15 ppmv, more preferably at most 10 ppmv, even more preferably at most 7.5 ppmv, most preferably at most 5.0 ppmv, and in particular at most 2.5 ppmv.

A further aspect of the invention relates to an apparatus comprising
(i) an NH₃-driven gas turbine; preferably an NH₃-driven internal combustion engine, an NH₃-driven gas turbine, or a furnace for cracking of NH₃ to N₂ and H₂; and
(ii) an offgas treatment system;
wherein the apparatus is configured for performance of the method as claimed in any of the preceding claims.

Particularly preferred embodiments of the invention are collated below as sentences:
Sentence 1: A method of reducing the content of NOₓ and N₂O in the offgas of an NH₃-operated firing system, wherein
Sentence 2: The method comprises the following steps: (a) combusting NH₃ to drive the firing system, producing an offgas which comprises N₂, H₂O, NOₓ and N₂O and which leaves the firing system; (b) transferring the offgas to an offgas treatment system; (c) reducing the N₂O content in the offgas by (c₁) decomposing N₂O over an N₂O decomposition catalyst and/or (c₂) chemically reducing N₂O with reducing agent over an N₂O reduction catalyst; and (d) reducing the NOₓ content in the offgas by chemical reduction of NOₓ with reducing agent over an NOₓ reduction catalyst.
Sentence 3: The method according to sentence 1, wherein the NH₃-operated firing system is an NH₃-driven internal combustion engine or an NH₃-driven gas turbine.
Sentence 4: The method according to sentence 1, wherein the NH₃-operated firing system is a furnace for cracking of NH₃ to N₂ and H₂.
Sentence 5: The method according to any of the preceding sentences, wherein the N₂O decomposition catalyst and/or the N₂O reduction catalyst and/or the NOₓ reduction catalyst independently comprise a zeolitic material; preferably a zeolite laden with transition metal (including lanthanide), in particular with iron, cobalt or copper; more preferably an iron-laden zeolite; even more preferably independently an iron-laden zeolite of the MFI, BEA, FER, MOR, FAU and/or MEL structure type.
Sentence 6: The method according to any of the preceding sentences, wherein the N₂O decomposition catalyst and the N₂O reduction catalyst are made from the same material.
Sentence 7: The method according to any of the preceding sentences, wherein the N₂O decomposition catalyst and the NOₓ reduction catalyst are made from the same material.
Sentence 8: The method according to any of the preceding sentences, wherein the N₂O reduction catalyst and the NOₓ reduction catalyst are made from the same material.
Sentence 9: The method according to any of the preceding sentences, wherein the N₂O decomposition catalyst, the N₂O reduction catalyst and the NOₓ reduction catalyst are made from the same material.
Sentence 10: The method according to any of the preceding sentences, wherein the combustion of NH₃ in step (a) is not over a catalyst.
Sentence 11: The method according to any of the preceding sentences, wherein NH₃ is combusted in step (a) in a mixture with a further combustible gas; preferably wherein the further combustible gas is selected from (i) H₂; (ii) fossil fuels; preferably hydrocarbons and hydrocarbon mixtures, more preferably methane, ethane, propane, butane, natural gas, petrol and/or diesel; (iii) alcohols, preferably methanol and/or ethanol; and mixtures thereof.
Sentence 12: The method according to any of the preceding sentences, wherein NH₃ is combusted in step (a) in a mixture with H₂.
Sentence 13: The method according to sentence 11, wherein step (a) comprises the following component steps: (a₁) thermal and/or catalytic cracking of NH₃ to produce a cracking gas comprising N₂, H₂ and optionally residual NH₃; (a₂) optionally mixing of cracking gas with further NH₃ to produce a mixture comprising H₂ and NH₃; (a₃) combusting the cracking gas or mixture.
Sentence 14: The method according to sentence 11 or 12, wherein the proportion of H₂ in the mixture with NH₃ is at most 80 mol %, more preferably at most 70 mol %, even more preferably at most 60 mol %, most preferably at most 50 mol %, and in particular at most 40 mol %.
Sentence 15: The method according to any of sentences 11 to 13, wherein the proportion of H₂ in the mixture with NH₃ is at least 10 mol %, more preferably at least 20 mol %, even more preferably at least 30 mol %, most preferably at least 40 mol %, and in particular at least 50 mol %.
Sentence 16: The method according to any of sentences 11 to 14, wherein the molar ratio of H₂:NH₃ in the mixture is in the range from 45:55 to 90:10, preferably 50:50 to 85:15, more preferably 55:45 to 80:20, even more preferably 60:40 to 75:25, most preferably 65:35 to 70:30.
Sentence 17: The method according to any of sentences 11 to 15, wherein the air ratio λ is in the range from 0.9 to 1.7, more preferably 1.0 to 1.6, even more preferably 1.1 to 1.5, most preferably 1.2 to 1.4.
Sentence 18: The method according to any of sentences 1 to 9, wherein NH₃ is combusted alone in step (a), and so NH₃ is the only combustible gas that is combusted.
Sentence 19: The method according to any of the preceding sentences, wherein the firing system, preferably the internal combustion engine, is mounted in a vehicle and is used to move the vehicle.
Sentence 20: The method according to sentence 18, wherein the vehicle is a ship.
Sentence 21: The method according to sentence 18, wherein the vehicle is a road vehicle; preferably selected from commercial vehicles, trucks and passenger cars; or a rail vehicle.
Sentence 22: The method according to any of the preceding sentences, wherein the firing system, preferably the gas turbine, is part of a power plant.
Sentence 23: The method according to sentence 21, wherein the power plant generates electrical power and/or district heating.
Sentence 24: The method according to any of the preceding sentences, wherein the firing system, preferably the furnace, is integrated into a system for thermal and/or catalytic cracking of NH₃ to N₂ and H₂.
Sentence 25: The method according to any of the preceding sentences, wherein the offgas has an NOₓ content greater than the N₂O content; preferably wherein the NOₓ content is at least twice as high, more preferably at least three times as high, even more preferably at least four times as high, most preferably at least seven times as high and in particular at least ten times as high as the N₂O content.
Sentence 26: The method according to any of the preceding sentences, wherein the offgas has an NO content greater than the N₂O content; preferably wherein the NO content is at least twice as high, more preferably at least three times as high, even more preferably at least four times as high, most preferably at least seven times as high and in particular at least ten times as high as the N₂O content.
Sentence 27: The method according to any of the preceding sentences, wherein the offgas has an NO₂ content greater than the N₂O content; preferably wherein the NO₂ content is at least twice as high, more preferably at least three times as high, even more preferably at least four times as high, most preferably at least seven times as high and in particular at least ten times as high as the N₂O content.
Sentence 28: The method according to any of sentences 1 to 23, wherein the offgas has an N₂O content greater than the NOₓ content; preferably wherein the N₂O content is at least twice as high, more preferably at least three times as high, even more preferably at least four times as high, most preferably at least seven times as high and in particular at least ten times as high as the NOₓ content.
Sentence 29: The method according to any of sentences 1 to 23 and 27, wherein the offgas has an N₂O content greater than the NO content; preferably wherein the N₂O content is at least twice as high, more preferably at least three times as high, even more preferably at least four times as high, most preferably at least seven times as high and in particular at least ten times as high as the NO content.
Sentence 30: The method according to any of sentences 1 to 23, 27 and 28, wherein the offgas has an N₂O content greater than the NO₂ content; preferably wherein the N₂O content is at least twice as high, more preferably at least three times as high, even more preferably at least four times as high, most preferably at least seven times as high and in particular at least ten times as high as the NO₂ content.
Sentence 31: The method according to any of the preceding sentences, wherein the offgas has an NOₓ content of at least 10 ppmv, preferably at least 20 ppmv, more preferably at least 30 ppmv, even more preferably at least 40 ppmv, and in particular at least 50 ppmv.
Sentence 32: The method according to any of the preceding sentences, wherein the offgas has an NOₓ content of at least 75 ppmv, preferably at least 100 ppmv, more preferably at least 150 ppmv, even more preferably at least 200 ppmv, and in particular at least 250 ppmv.
Sentence 33: The method according to any of the preceding sentences, wherein the offgas has an NOₓ content of at least 500 ppmv, preferably at least 1000 ppmv, more preferably at least 2000 ppmv, even more preferably at least 3000 ppmv, and in particular at least 3500 ppmv.
Sentence 34: The method according to any of the preceding sentences, wherein the offgas has an N₂O content of at least 10 ppmv, preferably at least 20 ppmv, more preferably at least 30 ppmv, even more preferably at least 40 ppmv, and in particular at least 50 ppmv.
Sentence 35: The method according to any of the preceding sentences, wherein the offgas has an N₂O content of at least 75 ppmv, preferably at least 100 ppmv, more preferably at least 150 ppmv, even more preferably at least 200 ppmv, and in particular at least 250 ppmv.
Sentence 36: The method according to any of the preceding sentences, wherein the offgas has an N₂O content of at least 500 ppmv, preferably at least 1000 ppmv, more preferably at least 2000 ppmv, even more preferably at least 3000 ppmv, and in particular at least 3500 ppmv.
Sentence 37: The method according to any of the preceding sentences, wherein the offgas has an H₂O content of less than 2.0% by volume.
Sentence 38: The method according to any of the preceding sentences, wherein the offgas has an H₂O content of more than 4.0% by volume; preferably at least 5.0% by volume, more preferably at least 6.0% by volume, even more preferably at least 7.0% by volume, most preferably at least 8.0% by volume, and in particular at least 9.0% by volume.
Sentence 39: The method according to any of the preceding sentences, wherein the offgas has an H₂O content of at least 10% by volume; preferably at least 12% by volume, more preferably at least 14% by volume, even more preferably at least 16% by volume, most preferably at least 18% by volume, and in particular at least 20% by volume.
Sentence 40: The method according to any of the preceding sentences, wherein the offgas has an H₂O content in the region of 10±8% by volume; preferably in the region of 10±7% by volume, more preferably in the region of 10±6% by volume, even more preferably in the region of 10±5% by volume, most preferably in the region of 10±4% by volume, and especially in the region of 10±3% by volume.
Sentence 41: The method according to any of the preceding sentences, wherein the offgas has an H₂O content in the region of 15±8% by volume; preferably in the region of 15±7% by volume, more preferably in the region of 15±6% by volume, even more preferably in the region of 15±5% by volume, most preferably in the region of 15±4% by volume, and especially in the region of 15±3% by volume.
Sentence 42: The method according to any of the preceding sentences, wherein the offgas has an H₂O content in the region of 20±8% by volume; preferably in the region of 20±7% by volume, more preferably in the region of 20±6% by volume, even more preferably in the region of 20±5% by volume, most preferably in the region of 20±4% by volume, and especially in the region of 20±3% by volume.
Sentence 43: The method according to any of the preceding sentences, wherein the offgas has an H₂O content in the region of 25±8% by volume; preferably in the region of 25±7% by volume, more preferably in the region of 25±6% by volume, even more preferably in the region of 25±5% by volume, most preferably in the region of 25±4% by volume, and especially in the region of 25±3% by volume.
Sentence 44: The method according to any of the preceding sentences, wherein the offgas has an H₂O content in the region of 30±8% by volume; preferably in the region of 30±7% by volume, more preferably in the region of 30±6% by volume, even more preferably in the region of 30±5% by volume, most preferably in the region of 30±4% by volume, and especially in the region of 30±3% by volume.
Sentence 45: The method according to any of the preceding sentences, wherein the offgas has an N₂ content of at most 95% by volume, preferably at most 90% by volume, more preferably at most 85% by volume, even more preferably at most 80% by volume, most preferably at most 75% by volume, and in particular at most 70% by volume.
Sentence 46: The method according to any of the preceding sentences, wherein the offgas has an N₂ content of at least 40% by volume, preferably at least 50% by volume, more preferably at least 60% by volume, even more preferably at least 70% by volume, most preferably at least 80% by volume, and in particular at least 90% by volume.
Sentence 47: The method according to any of the preceding sentences, wherein the offgas comprises further gaseous constituents; preferably selected from the group consisting of O₂, CO, CO₂, NH₃, CH₄ and mixtures thereof.
Sentence 48: The method according to any of the preceding sentences, wherein the offgas on departure from the firing system, preferably the internal combustion engine, the gas turbine or the furnace, is at a temperature of at least 500 °C, more preferably at least 600 °C, even more preferably at least 700 °C, most preferably at least 800 °C, and in particular at least 900 °C.
Sentence 49: The method according to any of the preceding sentences, wherein the offgas on departure from the firing system, preferably the internal combustion engine, the gas turbine or the furnace, is at a temperature of at most 1100 °C, more preferably at most 1000 °C, even more preferably at most 900 °C, most preferably at most 800 °C, and in particular at most 700 °C.
Sentence 50: The method according to any of the preceding sentences, wherein the offgas on departure from the firing system, preferably the internal combustion engine, the gas turbine or the furnace, is at a pressure of at most 1.5 bar; preferably atmospheric pressure.
Sentence 51: The method according to any of the preceding sentences, wherein the offgas on departure from the firing system, preferably the internal combustion engine, the gas turbine or the furnace, has a degree of oxidation of NOₓ of at least 10%, more preferably at least 20%, even more preferably at least 30%, most preferably at least 40%, and in particular at least 50%.
Sentence 52: The method according to any of the preceding sentences, wherein the offgas on departure from the firing system, preferably the the internal combustion engine, the gas turbine or the furnace, has a degree of oxidation of NOₓ of at most 90%, more preferably at most 80%, even more preferably at most 70%, most preferably at most 60%, and in particular at most 50%.
Sentence 53: The method according to any of the preceding sentences, wherein the offgas on departure from the firing system, preferably the the internal combustion engine, the gas turbine or the furnace, has an O₂ content of less than 2.0% by volume.
Sentence 54: The method according to any of sentences 1 to 28, wherein the offgas when leaving the internal combustion engine, preferably the internal combustion engine, the gas turbine or the furnace, has an O₂ content of more than 4.0% by volume.
Sentence 55: The method according to any of the preceding sentences, wherein the offgas on entry into the offgas treatment system is at a temperature of at least 300 °C, more preferably at least 350°C, even more preferably at least 400 °C, most preferably at least 425 °C, and in particular at least 450 °C.
Sentence 56: The method according to any of the preceding sentences, wherein the offgas on entry into the offgas treatment system is at a temperature of at least 500 °C, more preferably at least 550 °C, even more preferably at least 600°C, most preferably at least 625 °C, and in particular at least 650 °C.
Sentence 57: The method according to any of the preceding sentences, wherein the offgas on entry into the offgas treatment system is at a temperature of at most 825 °C, more preferably at most 800 °C, even more preferably at most 775 °C, most preferably at most 750 °C, and in particular at most 725 °C.
Sentence 58: The method according to any of the preceding sentences, wherein the offgas on entry into the offgas treatment system is at a temperature of at most 700 °C, more preferably at most 650 °C, even more preferably at most 600 °C, most preferably at most 550 °C, and in particular at most 500 °C.
Sentence 59: The method according to any of the preceding sentences, wherein the offgas on entry into the offgas treatment system is at a temperature which, in relative terms, is at least 20 °C, preferably at least 40 °C, more preferably at least 60 °C, even more preferably at least 80 °C, most preferably at least 100 °C, and in particular at least 120 °C, below the temperature of the offgas when leaving the internal combustion engine, preferably the internal combustion engine, the gas turbine or the furnace.
Sentence 60: The method according to any of the preceding sentences, wherein the offgas on entry into the offgas treatment system is at a pressure of at most 1.2 bar; preferably atmospheric pressure.
Sentence 61: The method according to any of the preceding sentences, wherein the offgas on entry into the offgas treatment system has a degree of oxidation of NOₓ of at least 10%, more preferably at least 20%, even more preferably at least 30%, most preferably at least 40%, and in particular at least 50%.
Sentence 62: The method according to any of the preceding sentences, wherein the offgas on entry into the offgas treatment system has a degree of oxidation of NOₓ of at most 90%, more preferably at most 80%, even more preferably at most 70%, most preferably at most 60%, and in particular at most 50%.
Sentence 63: The method according to any of the preceding sentences, wherein the offgas on entry into the offgas treatment system has an O₂ content of less than 2.0% by volume.
Sentence 64: The method according to any of sentences 1 to 36, wherein the offgas on entry into the offgas treatment system has an O₂ content of more than 4.0% by volume.
Sentence 65: The method according to any of the preceding sentences, wherein step (c) comprises reducing the N₂O content in the offgas by (c₁) decomposition of N₂O over an N₂O decomposition catalyst; preferably wherein the N₂O decomposition catalyst comprises a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL type.
Sentence 66: The method according to any of the preceding sentences, wherein step (c) comprises reducing the N₂O content in the offgas by (c₂) chemical reduction of N₂O with reducing agent over an N₂O reduction catalyst; preferably wherein the N₂O reduction catalyst comprises a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL type.
Sentence 67: The method according to any of the preceding sentences, wherein the reducing agent in step (c₂) is selected from NH₃, hydrocarbons, CO, H₂ and mixtures thereof; preferably NH₃.
Sentence 68: The method according to any of the preceding sentences, wherein the reducing agent in step (c₂) is NH₃, which is used in an amount of 0.5 to 2.0 molar parts, preferably 0.8 to 1.8 molar parts, based on a molar proportion of N₂O to be chemically reduced.
Sentence 69: The method according to any of the preceding sentences, wherein the reducing agent in step (c₂) is a hydrocarbon or a mixture of several hydrocarbons, which are preferably used in an amount of 0.2 to 1.0 molar part, more preferably of 0.2 to 0.7 molar part, based on a molar proportion of N₂O to be broken down.
Sentence 70: The method according to any of the preceding sentences, wherein the NOₓ reduction catalyst comprises a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL type.
Sentence 71: The method according to any of the preceding sentences, wherein the reducing agent in step (d) is selected from NH₃, hydrocarbons, CO, H₂ and mixtures thereof; preferably NH³.
Sentence 72: The method according to any of the preceding sentences, wherein the reducing agent in step (d) is NH₃, which is used in an amount of 0.9 to 2.5 molar parts, preferably 1.0 to 1.4 molar parts, more preferably 1.0 to 1.2 molar parts, based on a molar proportion of NOₓ to be chemically reduced.
Sentence 73: The method according to any of the preceding sentences, wherein the reducing agent in step (c₂) is the same as the reducing agent in step (d); preferably NH₃.
Sentence 74: The method according to any of the preceding sentences, wherein the offgas treatment system comprises a first reaction zone and a second reaction zone beyond, through which the offgas passes successively; wherein reducing agent is added to the offgas upstream of the first reaction zone; wherein, in the first reaction zone, the NOₓ content in the offgas is first reduced by chemical reduction of NOₓ with reducing agent over an NOₓ reduction catalyst (step (d)); wherein the N₂O content in the offgas is optionally additionally reduced by decomposition of N₂O over an N₂O decomposition catalyst (step (c₁)) and/or by chemical reduction of N₂O with reducing agent over an N₂O reduction catalyst (step (c₂)); wherein further reducing agent is optionally added to the offgas upstream of the second reaction zone; and wherein, in the second reaction zone, the N₂O content in the offgas is then reduced by decomposition of N₂O over an N₂O decomposition catalyst (step (c₁)) and/or by chemical reduction of N₂O with reducing agent over an N₂O reduction catalyst (step (c₂)); wherein the NOₓ content in the offgas is optionally additionally further reduced by chemical reduction of NOₓ over an NOₓ reduction catalyst (step (d)).
Sentence 75: The method according to sentence 73, wherein the NOₓ reduction catalyst in the first reaction zone comprises a conventional SCR catalyst, preferably based on V₂O₅—WO₃—/TiO₂.
Sentence 76: The method according to sentence 73 or 74, wherein the offgas temperature on entry into the first reaction zone is not more than 400 °C, preferably not more than 350 °C.
Sentence 77: The method according to any of sentences 73 to 75, wherein the N₂O decomposition catalyst in the second reaction zone comprises a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL type.
Sentence 78: The method according to any of sentences 73 to 76, wherein the offgas temperature on entry into the second reaction zone is in the range from 300 to 550 °C, preferably 350 to 500 °C.
Sentence 79: The method according to any of sentences 73 to 77, wherein the NOₓ reduction catalyst in the first reaction zone comprises a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL type.
Sentence 80: The method according to any of sentences 73 to 78, wherein the offgas temperature on entry into the first reaction zone is at least 300 °C, more preferably at least 350 °C, even more preferably at least 400 °C.
Sentence 81: The method according to any of sentences 73 to 79, wherein the offgas temperature on entry into the first reaction zone is not more than 600 °C, more preferably not more than 550 °C.
Sentence 82: The method according to any of sentences 73 to 80, wherein the N₂O decomposition catalyst in the second reaction zone comprises an NOₓ-sensitive N₂O decomposition catalyst.
Sentence 83: The method according to any of sentences 73 to 81, wherein the offgas temperature on entry into the second reaction zone is at least 300 °C, more preferably at least 350 °C, even more preferably at least 400 °C.
Sentence 84: The method according to any of sentences 73 to 82, wherein the offgas temperature on entry into the second reaction zone is not more than 600 °C, preferably not more than 550 °C.
Sentence 85: The method according to any of sentences 73 to 83, wherein the offgas after leaving the first reaction zone and before entering the second reaction zone has an NOₓ content in the range from 0 to 200 ppmv, preferably 1 to 200 ppmv, and an N₂O content in the range from 200 to 2000 ppmv.
Sentence 86: The method according to any of sentences 73 to 84, wherein the offgas after leaving the first reaction zone and before entering the second reaction zone has an NOₓ content of not more than 20 ppmv, more preferably not more than 10 ppmv, even more preferably not more than 5 ppmv, and an N₂O content in the range from 200 to 2000 ppmv.
Sentence 87: The method according to any of the preceding sentences, wherein the offgas treatment system comprises a first reaction zone and a second reaction zone beyond, through which the offgas passes successively; wherein reducing agent is added to the offgas between the first reaction zone and the second reaction zone; wherein, in the first reaction zone, the N₂O content in the offgas is first reduced by decomposition of N₂O over an N₂O decomposition catalyst (step (c₁)); and wherein, in the second reaction zone, the NOₓ content in the offgas is then reduced by chemical reduction of NOₓ with reducing agent over an NOₓ reduction catalyst (step (d)); wherein the N₂O content in the offgas is optionally additionally further reduced by further decomposition of N₂O over an N₂O decomposition catalyst (step (c₁)) and/or by chemical reduction of N₂O with reducing agent over an N₂O reduction catalyst (step (c₂)).
Sentence 88: The method according to sentence 86, wherein no reducing agent is added to the offgas upstream of the first reaction zone.
Sentence 89: The method according to sentence 86 or 87, wherein the N₂O decomposition catalyst in the first reaction zone comprises a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL type.
Sentence 90: The method according to any of sentences 86 to 88, wherein the N₂O decomposition catalyst in the first reaction zone comprises an NOₓ-sensitive N₂O decomposition catalyst.
Sentence 91: The method according to any of sentences 86 to 89, wherein the NOₓ reduction catalyst in the second reaction zone comprises a zeolitic material; preferably a zeolite laden with transition metal (including lanthanide), in particular with iron, cobalt or copper; more preferably an iron-laden zeolite; even more preferably an iron-laden zeolite of the MFI, BEA, FER, MOR, FAU and/or MEL type.
Sentence 92: The method according to any of sentences 86 to 90, wherein, in the first reaction zone and in the second reaction zone, the space velocity is set in such a way that the N₂O content in the offgas is reduced in the first reaction zone by at most 95%, preferably at most 90%, based on the N₂O content in the offgas on entry into the first reaction zone.
Sentence 93: The method according to any of sentences 86 to 91, wherein, in the second reaction zone, the N₂O content in the offgas is further reduced by at least 30%, preferably at least 40%, more preferably at least 50%, based on the N₂O content in the offgas on entry into the second reaction zone.
Sentence 94: The method according to any of sentences 86 to 92, wherein, in the second reaction zone, the N₂O content in the offgas is further reduced by chemical reduction of N₂O with reducing agent over an N₂O reduction catalyst (step (c₂)).
Sentence 95: The method according to any of sentences 73 to 93, wherein the first reaction zone and the second reaction zone are spatially separated.
Sentence 96: The method according to any of sentences 73 to 94, wherein the first reaction zone and the second reaction zone are spatially connected to each other.
Sentence 97: The method according to any of sentences 73 to 95, wherein the first reaction zone and the second reaction zone are disposed in a shared vessel.
Sentence 98: The method according to any of sentences 73 to 96, wherein the offgas temperature in the first reaction zone and in the second reaction zone is not more than 500 °C, preferably in the range from 350 to 450 °C.
Sentence 99: The method according to any of sentences 73 to 97, wherein the space velocity in the first reaction zone is greater than in the second reaction zone; preferably at least by a factor of 1.2, more preferably at least a factor of 1.4, even more preferably at least a factor of 1.6, most preferably at least a factor of 1.8, and in particular at least a factor of 2.0.
Sentence 100: The method according to any of sentences 73 to 98, wherein the space velocity in the first reaction zone is smaller than in the second reaction zone; preferably at least by a factor of 1.5, more preferably at least a factor of 2.0, even more preferably at least a factor of 3.0, most preferably at least a factor of 5.0, and in particular at least a factor of 10.0.

Sentence 101: The method according to any of sentences 73 to 99, wherein the temperature in the first reaction zone is at least 450 °C, more preferably at least 500 °C, even more preferably at least 550 °C, most preferably at least 600 °C and in particular at least 650 °C.
Sentence 102: The method according to any of sentences 73 to 100, wherein the temperature in the second reaction zone is at most 600 °C, more preferably at most 550 °C, even more preferably at most 500 °C, most preferably at most 450 °C and in particular at most 400 °C.
Sentence 103: The method according to any of sentences 73 to 101, wherein the temperature in the first reaction zone, in relative terms, is at least 20 °C, more preferably at least 40 °C, even more preferably at least 60 °C, most preferably at least 80 °C and in particular at least 100 °C higher than the temperature in the second reaction zone.
Sentence 104: The method according to any of sentences 73 to 102, wherein the temperature in the first reaction zone, in relative terms, is at least 120 °C, more preferably at least 140°C, even more preferably at least 160 °C, most preferably at least 180 °C and in particular at least 200 °C higher than the temperature in the second reaction zone.
Sentence 105: The method according to any of the preceding sentences, wherein the offgas leaves the offgas treatment system and has a residual NOₓ content of at most 20 ppmv, preferably at most 15 ppmv, more preferably at most 10 ppmv, even more preferably at most 7.5 ppmv, most preferably at most 5.0 ppmv, and in particular at most 2.5 ppmv.
Sentence 106: The method according to any of the preceding sentences, wherein the offgas leaves the offgas treatment system and has a residual N₂O content of at most 20 ppmv, preferably at most 15 ppmv, more preferably at most 10 ppmv, even more preferably at most 7.5 ppmv, most preferably at most 5.0 ppmv, and in particular at most 2.5 ppmv.
Sentence 107: The method according to any of the preceding sentences, wherein the N₂O decomposition catalyst is disposed in a radial basket through which the flow passes axially.
Sentence 108: The method according to any of the preceding sentences, wherein the N₂O decomposition catalyst is particulate and comprises at least 50 particles.
Sentence 109: The method according to any of the preceding sentences, wherein the N₂O reduction catalyst is disposed in a radial basket through which the flow passes axially.
Sentence 110: The method according to any of the preceding sentences, wherein the N₂O reduction catalyst is particulate and comprises at least 50 particles.
Sentence 111: The method according to any of the preceding sentences, wherein the NOₓ reduction catalyst is disposed in a radial basket through which the flow passes axially.
Sentence 112: The method according to any of the preceding sentences, wherein the NOₓ reduction catalyst is particulate and comprises at least 50 particles.
Sentence 113: The method according to any of the preceding sentences, wherein at least one parameter characteristic of the current operating state of the firing system is measured in the firing system as a first measured variable.
Sentence 114: The method according to sentence 112, wherein the first measured variable is selected from the group consisting of combustion temperature, NH₃ consumption, if appropriate speed of rotation, and the volume of the firing system.
Sentence 115: The method according to any of the preceding sentences, wherein at least one parameter characteristic of the current state of the offgas before entry into the offgas treatment system is measured as a second measured variable before entry into the offgas treatment system.
Sentence 116: The method according to sentence 114, wherein the second measured variable is selected from the group consisting of NOₓ content in the offgas; degree of oxidation of the NOₓ in the offgas; N₂O content in the offgas; content of other components in the offgas, for example H₂O, O₂, and N₂; offgas temperature; offgas pressure; and volume flow rate of the offgas.
Sentence 117: The method according to any of the preceding sentences, wherein at least one parameter characteristic of the current state of the offgas on departure from the exhaust gas treatment system is measured as a third measured variable on departure from the exhaust gas treatment system.
Sentence 118: The method according to sentence 116, wherein the third measured variable is selected from the group consisting of NOₓ content in the offgas; degree of oxidation of the NOₓ in the offgas; N₂O content in the offgas; content of other components in the offgas, for example H₂O, O₂, and N₂; offgas temperature; offgas pressure; and volume flow rate of the offgas.
Sentence 119: The method according to any of the preceding sentences, wherein the offgas treatment system comprises a first reaction zone and a second reaction zone, through which the offgas flows successively, wherein reducing agent is fed in between the first reaction zone and the second reaction zone, and wherein, after leaving the first reaction zone and before entering the second reaction zone, at least one parameter characteristic of the current state of the offgas after leaving the first reaction zone and before entering the second reaction zone is measured as a fourth measured variable.
Sentence 120: The method according to sentence 118, wherein the fourth measured variable is selected from the group consisting of NOₓ content in the offgas; degree of oxidation of the NOₓ in the offgas; N₂O content in the offgas; content of other components in the offgas, for example H₂O, O₂, and N₂; offgas temperature; offgas pressure; and volume flow rate of the offgas.
Sentence 121: The method according to any of sentences 112 to 119, wherein the control of the method is based on the first measured variable and/or on the second measured variable and/or on the third measured variable and/or on the fourth measured variable by means of a controlled change in a manipulated variable.
Sentence 122: The method according to sentence 120, wherein the manipulated variable is the amount of reducing agent metered in.
Sentence 123: An apparatus comprising (i) an NH₃-operated firing system; preferably an NH₃-driven internal combustion engine, an NH₃-driven gas turbine, or a furnace for cracking of NH₃ to N₂ and H₂; and (ii) an offgas treatment system; wherein the apparatus is configured for performance of the method according to any of the preceding sentences.

### LIST OF REFERENCE SYMBOLS

V: compressor
GT: gas turbine
VK: combustion chamber
AB: offgas treatment system
ADE1: first waste heat steam generator
ADE2: second waste heat steam generator
K1: first catalyst bed
K2: second catalyst bed
WT: heat exchanger
DT: steam turbine
SS: chimney

What is claimed is:

1. A method of reducing the content of NOₓ and N₂O in the offgas of an NH₃-operated firing system, preferably gas turbine, the process comprising the following steps:
(a) combusting NH₃ for operation of the firing system, preferably gas turbine, producing an offgas which comprises N₂, H₂O, NOₓ and N₂O and which leaves the firing system;
(b) transferring the offgas to an offgas treatment system;
(c) reducing the N₂O content in the offgas by:
(c₁) decomposing N₂O over an N₂O decomposition catalyst and/or
(c₂) chemically reducing N₂O with reducing agent over an N₂O reduction catalyst; and
(d) reducing the NOₓ content in the offgas by chemical reduction of NOₓ with reducing agent over an NOₓ reduction catalyst.

2. The method as claimed in claim 1, wherein the NH₃-operated firing system is an NH₃-driven gas turbine.

3.-5. (canceled)

6. The method as claimed in 1, wherein the N₂O decomposition catalyst and/or the N₂O reduction catalyst and/or the NOₓ reduction catalyst independently comprise a zeolitic material; preferably a zeolite laden with transition metal (including lanthanide), in particular with iron, cobalt or copper; more preferably an iron-laden zeolite; even more preferably independently an iron-laden zeolite of the MFI, BEA, FER, MOR, FAU and/or MEL structure type.

7.-8. (canceled)

9. The method as claimed in claim 1. wherein NH₃ is combusted in step (a) in a mixture with H₂.

10. The method as claimed in claim 9, wherein step (a) comprises the following component steps:
(a₁) thermally and/or catalytically cracking NH₃ to produce a cracking gas comprising N₂, H₂ and optionally residual NH₃;
(a₂) optionally mixing the cracking gas with further NH₃ to produce a mixture comprising H₂ and NH₃;
(a₃) combusting the cracking gas or the mixture.

11. The method as claimed in claim 9, wherein the proportion of H₂ is at most 50% by volume and wherein the combustion is preferably effected at an air ratio λ in the range from 2.0 to 3.0, more preferably 2.1 to 2.9, even more preferably 2.2 to 2.8.

12. The method as claimed in claim 9, wherein the proportion of H₂ is more than 50% by volume and wherein the combustion is preferably effected at an air ratio λ in the range from 2.5 to 3.5, more preferably 2.6 to 3.4, even more preferably 2.7 to 3.3.

13.-19. (canceled)

20. The method as claimed in claim 1, wherein an offgas is generated in step (a) that has a degree of oxidation of NOₓ of at most 5.0%, more preferably at most 4.0%, even more preferably at most 3.0%, most preferably at most 2.0% and in particular at most 1.0%, possibly even at most 0.5%.

21.-31. (canceled)

32. The method as claimed in claim 1, wherein NH₃ is combusted in step (a) in a mixture with CH₄ and the offgas therefore additionally comprises CO and CO₂ and preferably also HCN.

33.-46. (canceled)

47. The method as claimed in claim 1, wherein the offgas treatment system comprises a first catalyst bed and a spatially separated second catalyst bed;
wherein the first catalyst bed is disposed upstream of the second catalyst bed in flow direction of the offgas;
optionally wherein a first device with a first control valve for metered addition of NH₃ to the offgas is preferably disposed upstream of the first catalyst bed;
wherein downstream of the first catalyst bed and upstream of the second catalyst bed is disposed a second device with a second control valve for metered addition of NH₃ to the offgas, with which further NH₃ is metered into the offgas;
wherein both the first catalyst bed and the second catalyst bed each contain an iron-laden zeolite catalyst;
wherein:
(i) in the first catalyst bed
(c₁) the N₂O content in the offgas is reduced by catalytic decomposition of N₂O; and
(d) the NOₓ content in the offgas is incompletely reduced by catalytic chemical reduction of NOₓ with NH₃, where at least some of the NH₃ comes from an incomplete combustion of NH₃ in step (a) (NH₃ slip); and
(ii) in the second catalyst bed:
(c₂) the residual N₂O content is reduced by catalytic chemical reduction of N₂O with NH₃;
(c1*) the residual N₂O content is optionally reduced by catalytic decomposition of N₂O; and
(d*) the residual NOₓ content is reduced by catalytic chemical reduction of NOₓ with NH₃.

48. The method as claimed in claim 47, wherein the catalytic decomposition of N₂O in the first catalyst bed is cocatalyzed by NOₓ present in the offgas.

49. (canceled)

50. The method as claimed in claim 47, wherein additional NH₃ is metered into the offgas by means of the first device; preferably under feedback control; wherein a particular value for the concentration of NOₓ on departure from the first catalyst bed is preferably defined as the target value (setpoint) and the actual concentration of NOₓ on departure from the first catalyst bed is measured (actual value); and wherein, in the event of a difference between setpoint and actual value (control difference), the output of the first control valve is altered in order to minimize the difference.

51.-61. (canceled)

62. The method as claimed in claim 47, wherein the further NH₃ is metered in with the second device under feed-forward control; wherein the concentration of NOₓ and of N₂O is preferably measured on departure from the first catalyst bed; the amount of offgas entering the second catalyst bed is taken into account to calculate the required amount of NH₃; and the calculated result (manipulated variable) is used to alter the output of the second control valve in order to meter in the required amount of NH₃.

63.-83. (canceled)

84. The method as claimed in claim 1, wherein the N₂O decomposition catalyst and/or the N₂O reduction catalyst and the NOₓ reduction catalyst independently take the form of monolithic catalyst elements permeated by parallel channels, preferably in the form of monolithic honeycomb bodies.

85. An apparatus comprising:
(i) an NH₃-driven gas turbine; and
(ii) an offgas treatment system;
wherein the apparatus is configured for performance of the method as claimed in claim 1.
